(19) United States
(12) Patent Application Publication
(10) Pub. No.: US 2022/0388871 A1
(43) Pub. Date: Dec. 8, 2022

(54) Inline Pool/Spa Monitoring Device and System Including Pool/Spa Pump Operation Determination and Associated Methods

(71) Applicant: Hayward Industries, Inc., Berkeley Heights, NJ (US)

(72) Inventors: Scott Eklund, Cupertino, CA (US); Joshua Kennedy, Sunnyvale, CA (US); Justin Miller, Monte Sereno, CA (US); Troy Renken, Mooresville, NC (US); Joseph Tessitore, Clemmons, NC (US)

(73) Assignee: Hayward Industries, Inc., Berkeley Heights, NJ (US)

(21) Appl. No.: 17/774,314

(22) PCT Filed: Oct. 29, 2020
(86) PCT No.: PCT/US2020/058058

§ 371 Date: May 4, 2022

Related U.S. Application Data
(60) Provisional application No. 62/930,304, filed on Nov. 4, 2019.

(51) Int. Cl. C02F 1/00

(52) U.S. Cl. CPC C02F 1/008; C02F 2103/42

(57) ABSTRACT

Exemplary embodiments are directed to systems and methods for monitoring pool or spa water, and determining an operational status of a pool or spa pump. The system includes a monitoring device engaged with a component of a pool or spa plumbing system, and in communication with a server. The server receives data from the monitoring device relating to characteristics of water within the component detected by the monitoring device. Based on the received data, the server can determine whether the data should, be discarded, and a runtime of the pump. The server can also receive vibration energy information from the monitoring device, determine runtime events of the pump based thereon, and determine whether the data should be discarded based on the vibration energy information. An adapter for coupling a monitoring device to a pool or spa plumbing system component, and retaining fluid within a reservoir portion thereof is also provided.

### CROSS-REFERENCE TO RELATED APPLICATIONS

This application claims the benefit of priority to U.S. Provisional Patent Application Ser. No. 62/930,304, filed on Nov. 4, 2019, the entire disclosure of which is expressly incorporated by reference herein in its entirety.

### TECHNICAL FIELD

The present disclosure relates generally to the field orf monitoring devices and systems for pools and spas. More specifically, the present disclosure relates to an inline monitoring device and system for monitoring and measuring characteristics, of bodies of water including, but not limited to, a swimming pool, a spa, a hot tub, and other sports, recreational and therapeutic bodies of water, that determines and considers whether an associated pump is operating.

### RELATED ART

In the pool and spa field, systems are being developed to readily monitor and measure characteristics of a body of water (e.g., chemical levels) in order to maintain the quality of the water therein, which can be important for a wide variety of circumstances. For example, the water in swimming pools, spas, hot tubs, and other sports, recreational, and therapeutic bodies of water may be maintained at certain chemical levels for aesthetic, sanitary, and regulatory purposes, to maintain water clarity, prevent waterborne illnesses, and comply with municipal and federal codes. Some owners of pools and spas try to monitor, measure, and manage the chemical levels and quality of the pool/spa water by utilizing a litmus paper, reagent drops, or over the counter testing kits, while other owners rely on third party services. However, these approaches can be manually intensive, time-consuming, limited in operating range, and lack data processing power. Additionally, some of these options are susceptible to human error, while third party services can be relatively expensive.

One approach to monitor, measure, and manage the chemical levels and quality of the water in a pool or spa includes monitoring and measuring characteristics of the water in a plumbing system thereof. However, monitoring and measuring characteristics of the water in a pool or spa plumbing system can be challenging as it is generally desired for the water being tested to be representative of the entire pool or spa. Particularly, when the pool or spa pump is inactive, e.g., the pool or spa pump has not been running, the pool or spa water in the plumbing system can be stagnant and affected by environmental factors at a different rate compared to water in the pool or spa body. The stagnant water can sometimes skew certain chemical readings and provide incorrect data to a monitoring system. That is, the stagnant water may not be an accurate representation of the entire pool or spa. However, when the pool or spa pump is active and water is being circulated through the pool or spa plumbing system, the water in the plumbing system is not stagnant and is therefore less likely to be affected by environmental factors at a different rate compared to water in the pool or spa body. Accordingly, the water circulating through the pool or spa plumbing system is a more accurate representation of the entire pool or spa.

Accordingly, there is a need for an inline monitoring device and system that detects and/or determines when a pool or spa pump is active and considers pump activity to more accurately monitor and measure characteristics of pool or spa water.

### SUMMARY

The present disclosure relates to an inline pool/spa monitoring device and system including pool/spa pump operation determination and associated methods. The inline monitoring device and associated systems and methods provide for monitoring and measuring characteristics of bodies of water including, but not limited to, a swimming pool, a spa and other sports, recreational and therapeutic bodies of water.

In accordance with embodiments of the present disclosure, exemplary systems for monitoring pool or spa water are provided. The system can include a server having apt analytics engine, and a monitoring device. The monitoring device can be configured to be engaged with a component of a pool or spa plumbing system, and can include at least one sensor, a memory, a communication module, and a processor in communication with the at least one sensor, the memory, and the communication module. The at least one sensor can be configured to measure a characteristic of water within the component, and can be exposed to water within the component when the monitoring device is engaged with the component. The processor can be configured to establish communication between the monitoring device and the server, and communicate data related to the characteristic measured by the at least one sensor. The monitoring device communicates the data to the server, which receives the data. The analytics engine of the server (a) processes the data in connection with a runtime schedule of the pool or spa pump, (b) determines if the data was measured at a time when the pool or spa pump was operational, and (c) discards the data if it is determined that the data was not measured at a time when the pool or spa pump was operational.

In some embodiments, the system can include a calculation engine that generates a pool or spa water status report based on the data. The pool or spa water status report can include instructions to initiate one or more actions in connection with the pool or spa water. In other embodiments, the analytics engine can determine if the pool or spa pump was operational for more than a predetermined threshold prior to the time when the data was measured, and discard the data if it is determined that the pump was not operational for more than the predetermined threshold prior to the time when the data was measured. In still other embodiments, the analytics engine processes the data to filter out data outliers.

In some embodiments, the analytics engine can determine an average value for the data over a time period, and generate a pool or spa water status report based on the average value for the data over the time period. In such embodiments the pool or spa water status report can include instructions to initiate one or more actions in connection with the pool or spa water.

In some embodiments, the communication module can be a wireless communication module or a wired communication module. In other embodiments, the component can be a pipe, a pump, a filter, or a heater.

In accordance with embodiments of the present disclosure, an exemplary system for monitoring pool or spa water and determining an operational status of a. pool or spa pump includes a server having an analytics engine, and a monitoring device that can be configured to be engaged with a component of a pool or spa plumbing system. The monitoring device can include at least one sensor, a memory, a communication module, and a processor in communication with the at least one sensor, the memory, and the communication module. The sensor can be configured to measure two or more characteristics of water within the component, and can be exposed to water within the component when the monitoring device is installed in the component. The processor can be configured to establish communication between the monitoring device and the server, and communicate data related to the two or more characteristics measured by the at least one sensor. The monitoring device communicates the data to the server, which receives the data. The analytics engine can determine a runtime of the pool or spa pump based on the data related to both of the two or more characteristics.

In some embodiments, the analytics engine can determine if the data was measured at a time when the pool or spa pump was operational and discard the data if it is determined that the data was not measured at a time when the pool or spa pump was operational. In such embodiments, the server can include a calculation engine that generates a pool or spa water status report based on the data. The pool or spa water status report can include instructions to initiate one or more actions in connection with the pool or spa water.

In some embodiments, the analytics engine can (1) determine a rate of change between successive data points for the data related to each of the two or more characteristics of the pool or spa water, (2) determine whether the data for each of the two or more characteristics of the pool or spa water changed during a sample time period, the sample time period being the same for each of the two or more characteristics, (3) amplify the data for each of the two or more characteristics of the pool or spa water if it is determined to have changed during the sample time period, (4) determines if any rate of change repeated over a twenty-four hour time period, (5) amplify any rate of change that is determined to have repeated over the twenty-four hour time period, (6) determine if any rate of change repeated over a weekly time period, (7) amplify any rate of change that is determined to have repeated over the weekly time period, (8) identify peaks of rate of change, and (7) determine pool or spa pump on and off events based on the identified peaks of rate of change. In such embodiments, the analytics engine can compare the determined pool or spa pump on and off events with a pump runtime schedule and confirm any determined pool or spa pump on and off events that coincide with the pump runtime schedule. Additionally, the server can generate an error notification if any determined pool or spa pump on and off event does not coincide with the pump runtime schedule.

In some embodiments, the communication module can be a wireless communication module or a wired communication module. In other embodiments, the component can be a pipe, a pump, a filter, or a heater.

In accordance with embodiments of the present disclosure, an exemplary system for monitoring pool or spa. water and determining an operational status of a pool or spa pump includes a server having an analytics engine, and a monitoring device that can be configured to be engaged with a component of a pool or spa plumbing system. The monitoring device can include at least one sensor, an accelerometer, a memory, a communication module, and a processor in communication with the at least one sensor, the accelerometer, the memory, and the communication module. The sensor can be configured to measure a characteristic of water within the component, and can be exposed to water within the component when the monitoring device is engaged with the component. The processor can be configured to establish communication between the monitoring device and the server, and determine vibration energy integers for a. plurality of sample time periods based on measurements from the accelerometer. The monitoring device communicates the vibration energy integers and the data to the server, which receives the vibration energy integers and the data. The analytics engine can (a) determine runtime events of the pool or spa pump including operational periods based on the vibration energy integers, (b) process the data in connection with the runtime events of the pool or spa pump, (c) determine if the data was measured during an operational period of the pool or spa pump, and (d) discard the data if it is determined that the data was not measured during an operational period of the pool or spa pump.

In some embodiments, the server can include a calculation engine that can generate a pool or spa water status report based on the data. In such embodiments, the pool or spa water status report can include instructions to initiate one or more actions in connection with the pool or spa water.

In some embodiments, the analytics engine can determine if the pool or spa pump was operational for more than a predetermined threshold prior to the time when the data was measured, and discard the data if it is determined that the pump was not operational for more than the predetermined threshold prior to the time when the data was measured. In such embodiments, the analytics engine can process the data to filter out data outliers, and can determine an average value for the data over a time period. The server can then generate a pool or spa water status report based on the average value for the data over the time period. The pool or spa water status report can include instructions to initiate one or more actions in connection with the pool or spa water.

In some embodiments, the processor can determine a vibration energy value for the plurality of sample time periods based on measurements from the accelerometer and determine the vibration energy integer for each sample time period based on the vibration energy value for that sample time period. In such embodiments, the analytics engine can identify sample time periods of consistent high vibration energy based on the vibration energy integers, and determine runtime events of the pool or spa pump based on the sample time periods of consistent high vibration energy.

In some embodiments, the communication module can be a wireless communication module or a wired communication module. In other embodiments, the component can be a pipe, a pump, a filter, or a heater.

In accordance with embodiments of the present disclosure, an exemplary method of monitoring pool or spa water is provided. In the method, characteristics of pool or spa water are measured within a component of a pool or spa plumbing system using at least one sensor. Data related to the characteristic of the pool or spa water measured by the at least one sensor is transferred to a server. The data can include a series of data points each having a timestamp. The data is then processed in connection with a runtime schedule of the pool or spa pump including operational periods of the pool or spa pump. It is then determined if the data was measured during an operational period of the pool or spa pump, and the data is discarded if it is determined that the data was not measured during an operational period of the pool or spa pump.

In some embodiments, a pool or spa water status report can be generated based on the data. In other embodiments, instructions to initiate one or more actions in connection with the pool or spa water can be transmitted

In some embodiments, it can be determined if the pool or spa pump was operational for more than a predetermined threshold prior to the time when the data was measured, the data can be discarded if it is determined that the pump was not operational for more than the predetermined threshold prior to the time when the data was measured.

In other embodiments, the data can be processed to filter out data outliers, or an average value for the data over a time period can be determined. In such embodiments, a pool or spa water status report can be generated based on the data or instructions to initiate one or more actions in connection with the pool or spa water can be transmitted.

In some embodiments, the data can be transmitted wirelessly. In other embodiments, the component can be a pipe, a pump, a filter, or a heater.

In accordance with embodiments of the present disclosure, an exemplary method of monitoring pool or spa. water and determining an operational status of a pool or spa pump is provided. In the method, characteristics of pool or spa water within a component of a pool or spa plumbing system are measured using at least one sensor. Data related to each of the two or more characteristics of the pool or spa water measured by the at least one sensor are transmitted to a server. The data for each characteristic can include a series of data points each having a timestamp. Pool or spa pump runtimes are then determined based on the data related to both of the two or more characteristics.

In some embodiments, the step of determining pool or spa pump runtimes based on the data related to each of the two or more characteristics can involve additional steps. Particularly, a rate of change can be determined between successive data points for the data related to each of the two or more characteristics of the pool or spa water. It can then be determined whether the data for both of the two or more characteristics of the pool or spa water changed during a sample time period, which can be the same for each of the two or more characteristics. The data for both of the two or more characteristics of the pool or spa water can then be amplified if it is determined that the data for both of the two or more characteristics changed during the sample time period. Next, it can be determined if any rate of change repeated over a first time period. Any rate of change that is determined to have repeated over the first hour time period can then be amplified. It can then be determined if any rate of change has repeated over a second time period. If so, any rate of change that is determined to have repeated over the second time period can then be amplified. Peaks of rate of change can the be identified, and it pool or spa pump on and off events can be determined based on the identified peaks of rate of change.

In some embodiments, the determined pool or spa pump on and off events can be compared with a pump runtime schedule, any determined pool or spa pump on and off events that coincide with the pump runtime schedule can be confirmed. In such embodiments, an error notification can be generated if any determined pool or spa pump on and off events do not coincide with the pump runtime schedule.

In some embodiments, the first time period can be a four hour time period, a six hour time period, an eight hour time period, a twelve hour time period, or a twenty-four hour time period. In such embodiments, the second time period can be a weekly time period.

In sonic embodiments, it can be determined if the data related to each of the two or more characteristics of the pool or spa water was measured during one of the pool or spa pump runtimes, and any data related to each of the two or more characteristics of the pool or spa water can be discarded if the data is determined to not have been measured during one of the pool or spa runtimes. In such embodiments, a pool or spa water status report can be generated based on the data, or instructions to initiate one or more actions in connection with the pool or spa water can be transmitted.

In some embodiments, the data can be transmitted wirelessly. In otherembodiments, the component can be a pipe, a pump, a filter, or a heater.

In accordance with embodiments of the present disclosure, an exemplary method of monitoring pool or spa water and determining an operational status of a pool or spa pump is provided. A characteristic of pool or spa water within a component of a pool or spa plumbing system is measured using at least one sensor. An acceleration or displacement associated with the component is measured using an accelerometer. Vibration energy integers are then determined for a plurality of sample time periods based on the acceleration or displacement measured by the accelerometer. The vibration energy integers and the data related to the characteristic of the pool or spa water measured by the at least one sensor are then transmitted to a server. Runtime events of the pool or spa pump, including operational periods, can then be determined based on the vibration energy integers. The data in connection with the runtime events of the pool or spa pump can then be processed. It can then be determined if the data was measured during an operational period of the pool or spa pump, and any data can be discarded if it is determined that the data was not measured during an operational period of the pool or spa pump.

In some embodiments, a pool or spa water status report can be generated based on the data. in other embodiments, a instructions to initiate one or more actions in connection with the pool or spa water can be transmitted.

In some embodiments, it can be determined if the pool or spa pump was operational for more than a predetermined threshold prior to the time when the data was measured, and the data can be discarded if it is determined that the pump was not operational for more than the predetermined threshold prior to the time when the data was measured.

In other embodiments, the data can be processed to filter out data outliers, and an average value for the data over a time period can be determined. In such embodiments, a pool or spa water status report can be generated based on the data or instructions to initiate one or more actions in connection with the pool or spa water can be transmitted.

In other embodiments, a vibration energy value for the plurality of sample time periods can be determined based on the acceleration or displacement measurements of the accelerometer, and the vibration energy integer for each sample time period can be determined based on the vibration energy value for that sample time period. In such embodiments, sample time periods of consistent high vibration energy can be identified based on the vibration energy integers, and runtime events of the pool or spa pump can be determined based on the sample time periods of consistent high vibration energy.

In some embodiments, the data can be transmitted wirelessly. In other embodiments, the component can be a pipe, a pump, a filter, or a heater.

In accordance with embodiments of the present disclosure, an exemplary adapter for coupling a water monitoring device to a component of a pool or spa plumbing system includes a cylindrical collar, a threaded collar, and a reservoir portion. The cylindrical collar can include an annular wall that is configured to receive a portion of a mounting rod of the monitoring device. The threaded collar can include an annular wall with threading on an interior thereof, which can be configured to engage a threaded portion of the mounting rod. The reservoir portion can define a chamber configured to receive and house at least one sensor of the monitoring device. The reservoir portion can also include one or more slots that extend there through and place the chamber in fluidic communication with an exterior of the reservoir portion. The reservoir portion can be configured to receive fluid through the one or more slots and retain at least a portion of the fluid in the chamber

In some embodiments, the threaded collar can extend from the cylindrical collar and the reservoir portion can extend from the threaded collar. In such embodiments, the adapted can include an annular shoulder extending from a bottom edge of the cylindrical collar to a top edge of the threaded collar. The annular shoulder can be configured to engage a portion of the component and limit an insertion depth of the adapter into an interior of the component.

In other embodiments, the threaded collar and the reservoir portion can be configured to extend through an aperture of the component and into an interior thereof. In still other embodiments, the cylindrical collar can be configured to engage a portion of the component to secure the adapted to the component.

In some embodiments, the reservoir portion can be configured to reduce the force of fluid flowing through the one or more slots and into the reservoir portion.

Other features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

The foregoing features of the present disclosure will be apparent from the following Detailed Description of the Invention, taken in connection with the accompanying drawings, in which:

FIG. 1 is a chart illustrating a comparison between measurements of an inline monitoring device for pH, Oxidation Reduction Potential (ORP), and temperature of pool/spa water with the actual values for pH, ORP and temperature of the pool/spa water, and showing when the pool or spa pump is active and when the pool or spa pump is inactive;

FIG. 2 is a front elevation view of the inline monitoring device of the present disclosure, and an associated client application running on a remote user device and generating a graphic user interface;

FIG. 3 is a diagram illustrating interior hardware components of the inline monitoring device of FIG. 1;

FIG. 4 is a block diagram illustrating components of the inline monitoring device of FIG. 1;

FIG. 5 is a perspective view of the inline monitoring device of FIG. 1 coupled to a component of a pool or spa plumbing system;

FIG. 6 is a diagram illustrating an inline monitoring device system of the present disclosure;

FIG. 7 is a flowchart illustrating processing steps of an embodiment of the present disclosure for monitoring and measuring characteristics of a pool or spa that takes into account a pump schedule;

FIG. 8 is a diagram illustrating a client application graphic user interface associated with Step 402 of FIG. 7;

FIG. 9 is a flowchart illustrating Step 410 of FIG. 7 in greater detail;

FIG. 10 is a flowchart illustrating processing steps of another embodiment of the present disclosure for monitoring and measuring characteristics of a pool or spa that takes into account variations in measurement data;

FIG. 11 is a flowchart illustrating Step 510 of FIG. 10 in greater detail;

FIG. 12 is a flowchart illustrating Step 548 of FIG. 11 in greater detail;

FIG. 13 is a flowchart illustrating processing steps of another embodiment of the present disclosure for monitoring and measuring characteristics of a pool or spa that takes into account accelerometer data;

FIG. 14 is a flowchart illustrating Step 602 of FIG. 13 in greater detail;

FIG. 15 is a flowchart illustrating Step 604 of FIG. 13 in greater detail;

FIG. 16 is a diagram illustrating a side view of an installation of an inline monitoring system installed in a pipe of a pool or spa plumbing system;

FIG. 17 is a partial sectional diagram view of the installation of FIG. 16;

FIG. 18 is a perspective view of an adapter for coupling a monitoring device of the present disclosure to a component of a pool or spa plumbing system;

FIG. 19 is a side elevation view of the adapter of FIG. 18;

FIG. 20 is a bottom view of the adapter of FIG. 18;

FIG. 21 is a cross-sectional view of the adapter of FIG. 18 taken along line A-A of FIG. 20; and

FIG. 22 is a partial sectional view illustrating the adapter of FIG. 18 installed in an exemplary component of a pool or spa plumbing system and having a monitoring device of the present disclosure engaged therewith.

### DETAILED DESCRIPTION

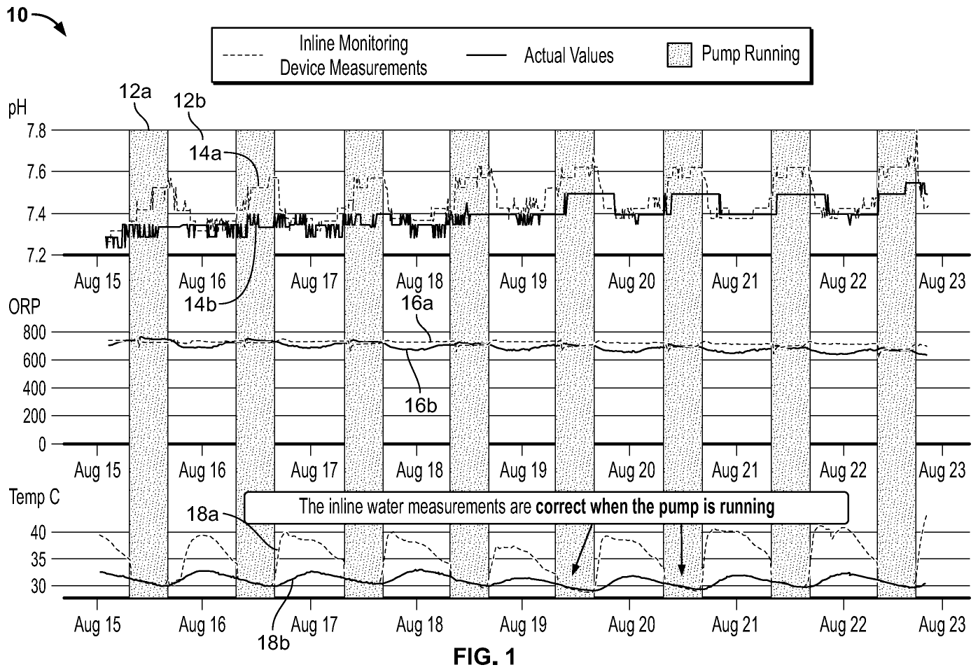

The present disclosure relates to an inline monitoring device and system for monitoring and measuring characteristics of bodies of water and associated methods, as described in detail below in connection with FIGS. 1-22.

FIG. 1 is a chart 10 illustrating a comparison between measurements of an inline monitoring device for pH, Oxidation Reduction Potential (ORP), and temperature of pool or spa water with the actual values for pH, ORP, and temperature of the pool or spa water, and showing when the pool or spa pump is active and when the pool or spa pump is inactive. In particular, the chart 10 illustrates three separate charts comparing an inline monitoring device pH measurement 14a and an actual pH value 14b, an inline monitoring device ORP measurement 16a and an actual ORP value 16b, and an inline monitoring device temperature measurement 18a and an actual temperature value 18b. Further, each chart provides a comparison of the inline monitoring device measurement and the actual value during a period when the pump is running 12a and during a period when the pump is not running 12b over a nine day time period (i.e., August 15 to August 23). That is, the periods when the pump is running are shown in shading on the chart 10.

As can be seen in FIG. 1, the measurements of the inline monitoring device are similar to the actual pool or spa values when the pool or spa pump is running (e.g., for those time periods 12a falling within the vertical shaded bars), particularly for water temperature and oxygen reduction potential (ORP) measurements. However, the pH, water temperature, and ORP measurements deviate from the actual pool or spa values when the pump is not running (e.g., for those time periods 12b that are not shaded).

For example, as seen in FIG. 1, the inline water temperature measurement can deviate by as much as seven degrees Celsius from the actual value when the pool or spa pump is not running. Accordingly, it is important to detect and/or determine when the pool or spa pump is running, and use this information to provide more accurate monitoring and measurement readings of the pool or spa water flowing through the pool or spa plumbing system.

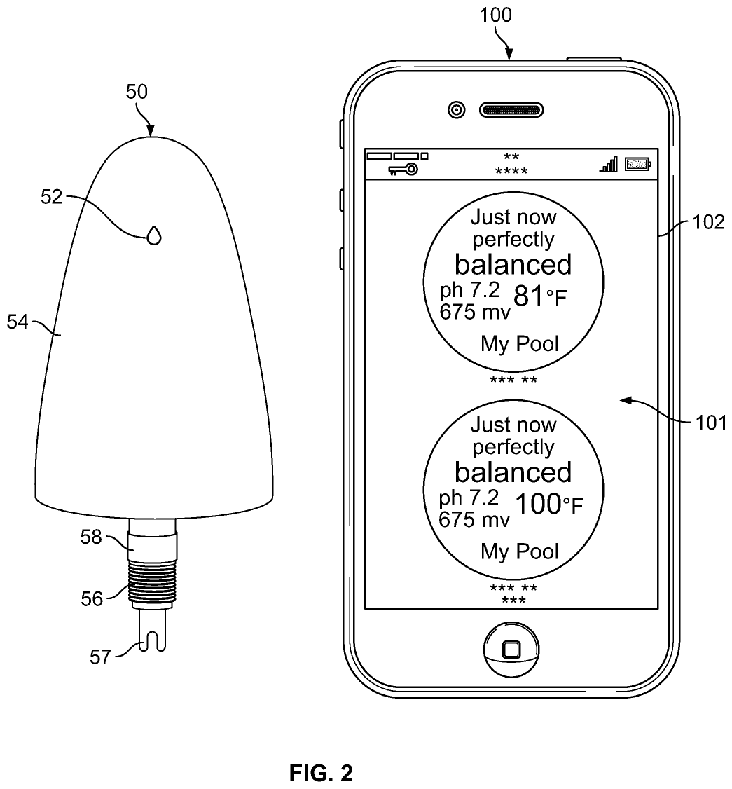

FIG. 2 illustrates an inline monitoring device 50 of the present disclosure and an associated client application 102 running on a remote user device 100 and generating a graphic user interface 101. The inline monitoring device 50 is configured to he engaged with or connected to a component of a pool or spa plumbing system. For example, the inline monitoring device 50 can be engaged with a pipe, e.g., a return pipe to the pool or spa or an exit pipe from the pool or spa pump, and can monitor and measure characteristics of pool or spa water in the pipe including, but not limited to, pH value, chlorine level, bromine level, ORP, water temperature, total hardness, total alkalinity, cyanuric acid level, total dissolved solids, phosphate levels, and/or metal levels. Alternatively, the inline monitoring device 50 can be engaged with a pump (e.g., the pressure side of the pump through a pressure side drain hole (pressure sump) or the vacuum side of the pump through a vacuum side drain hole (vacuum sump)), a filter (e.g., through a drain hole of the filter), a heater (e.g., a heater water manifold), or any other component or water reservoir within the plumbing system of the pool or spa. that pool/spa water is circulated through. Accordingly, reference throughout the present disclosure of a pipe should be understood to be one example of a component that the inline monitoring device 50 can be engaged with, and any description associated therewith should be understood to be equally applicable to any other component of the pool or spa plumbing system through which pool/spa water is circulated.

The inline monitoring device 50 comprises a housing 54 and a mounting rod 58. The housing 54 can have an aperture 52 to display a light-emitting diode (LED) indicator (not shown) and is coupled to the mounting rod 58, which has a threaded portion 56 and at least one sensor 57. The housing 54 can be made of a plastic material that is resistant to damage from impact, sunlight, and chlorine or other chemicals present in pool or spa water. For example, the housing 54 can be comprised of a plastic material including, but not limited to, polypropylene, polyethylene, vinyl, polyester, polycarbonate, XENOY, or combinations thereof.

The mounting rod 58 is configured to be coupled, e.g., via a threaded aperture or a tee, to a pipe of a pool or spa plumping system such that the inline monitoring device 50 is inline with the pipe when coupled thereto with the sensor 57 extending into the pipe. As such, the sensor 57 is exposed to the water in the pipe. The mounting rod 58 encases the at least one sensor 57 for monitoring and measuring characteristics of the pool or spa water flowing through the pipe of the pool or spa plumbing system.

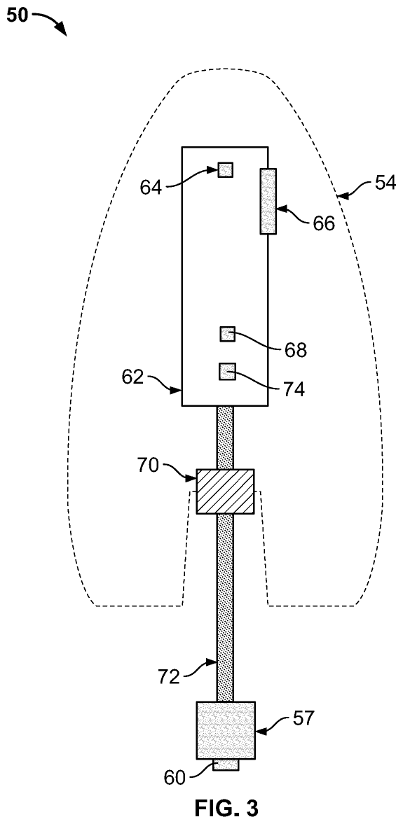

The sensor 57 may include, but is not limited to, any one or combination of a pH sensor, a chlorine sensor, a bromine sensor, a temperature sensor, and a voltage meter, which may respectively monitor and measure a pool or a spa pH, chlorine level, bromine level, temperature, and stray voltage. It is noted that an optional flowmeter 60 (see FIG. 3) can be integrated into the sensor 57 or be integrated with the inline monitoring device 50 independent of the sensor 57. The flowmeter 60 detects and measures flow and can include, but is not limited to, a paddle wheel that utilizes a hall-effect sensor to detect flow, a single level that moves in the presence of flowing water to trigger a hall-effect sensor, and a conductive wire that changes resistance as it bends in the present of flowing water to detect the presence of flow. The submerged portion of the mounting rod 58 may include one or more defined openings to permit the water to contact the sensor 57 and the flowmeter 60 in order to monitor and measure the characteristics of the water flowing through the pipe.

The housing 54 houses electronic components that wirelessly transmit the monitored and measured characteristics of the pool or spa water flowing through the pipe, in addition to other related data, to at least one of a client application being executed on a remote device 100 of a user (e.g., an application operating on a smart telephone) and/or a hosted service e.g., a server system) for analysis. The electronic components may include, but are not limited to, a processor, a memory, a wireless transceiver, an LED indicator, a sensor interface, an accelerometer, a reed switch, a gyroscope, and a power supply, and are discussed in greater detail in connection with FIG. 3. The reed switch can be used to initiate power to the electronic components via the application of a magnetic field applied externally to the housing 54 and adjacent to the reed switch. As such, the housing 54 can be void of externally accessible controls and is waterproof

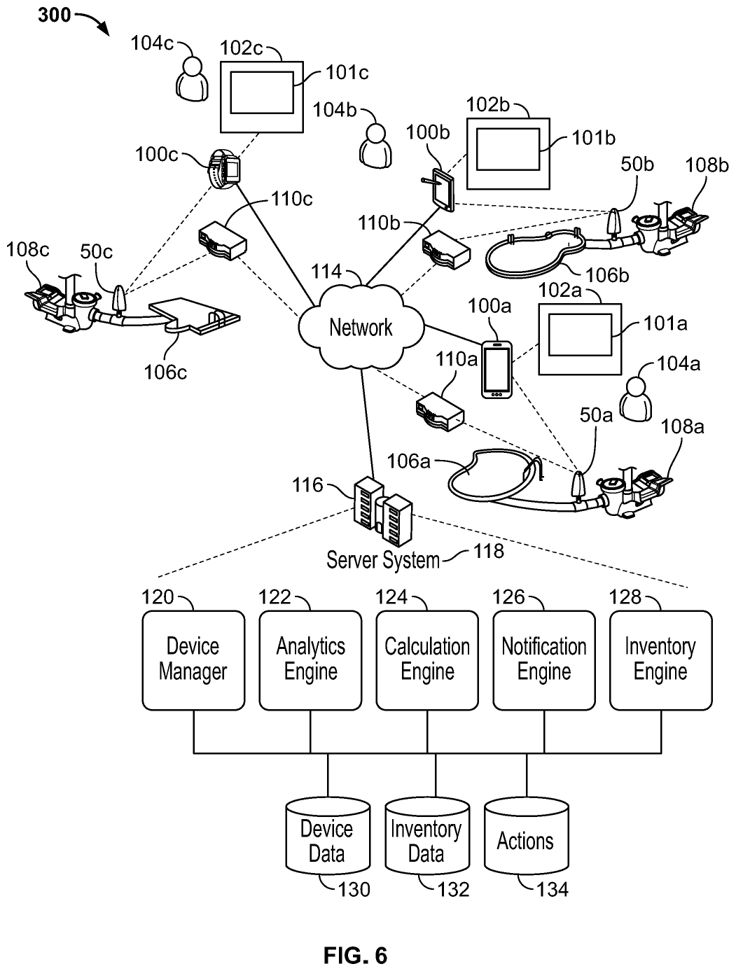

The inline monitoring device 50 is configured to wirelessly connect to the remote user device 100 (e.g., an owner of a pool or spa). It is noted that the inline monitoring device 50 is also configured to wirelessly connect to a Hub 110a-c (see FIG. 6), e.g., a router or BLE-Wifi Bridge, such that the inline monitoring device 50 can be connected to the Internet even when the user's remote device 100 is not within wireless communication range of the inline monitoring device 50. Additionally, the inline monitoring device 50 can include a Long Range Wide Area Network (LoRaWAN®) module or cellular module that can enable the inline monitoring device 50 to wirelessly connect directly to an infrastructure component (e.g., a gateway or a cell tower) for connection to the Internet. The wireless connection between the inline monitoring device 50 and the remote device 100 or the Hub 110a-c can he based on Bluetooth™ or Wi-Fi protocols. It is noted that other protocols for the wireless connection between the inline monitoring device 50 and the remote device 100 or the Hub 110a-c are possible. It is additionally noted that the inline monitoring device 50 can also be configured to connect to the Hub 100a-c through a wired communication between the inline monitoring device and the Hub 100a-c (e.g., Ethernet).

A client application 102 can be provided for operation on a remote user device 100, and can generate a graphic user interface 101 on the remote user device 100 that is configured to display characteristics of the pool or spa water transmitted from the inline monitoring device 50. This can include, for example, notifications indicative of pool or spa water chemical levels and/or user actions/instructions based on the identified pool or spa water chemical levels.

For example, one type of notification can inform the user of the current chemical level of the pool or spa water and direct the user to apply a particular chemical to the pool or spa water to maintain a desired sanitary condition and/or chemical level of the pool or spa water. After viewing the notification, the user can apply one or more pods containing a particular chemical or mixture of chemicals to the pool or spa. The pod packaging can dissolve in water thereby releasing the contents of the pod into the pool or spa water. For example, the pod packaging can comprise a polymer that dissolves in water such as polyvinyl alcohol (PVA). Alternatively, the user can open the pod packaging and pour the contents thereof into the pool or spa.

The pod or the contents thereof can be color coded to identify the one or more particular chemicals within the pod. For example, the chemical to color mapping can include, but is not limited to, the following: Trichlor tabs Light Green; pH Down Yellow; pH Up Orange; Bromine tablets Red; Sodium Bromide Purple; Dichlor Dark Blue; Trichlor Stix Light Blue; Non Chlorine Shock Dark Green. Alternatively or additionally, the pod may include a label that identifies the one or more particular chemicals therein, the color thereof and/or a respective amount of the one or more particular chemicals therein. For example, the label can include, but is not limited to, the following: “Chlorine,” “Blue Chlorine,” and “Blue-Chlorine 450 grams,” etc. The foregoing can be in accordance with the disclosure of U.S. Pat. No. 9,834,451 filed on Mar. 16, 2017 and entitled “Chemical Monitoring Devices and Methods,” the entirety of which is incorporated by reference herein.

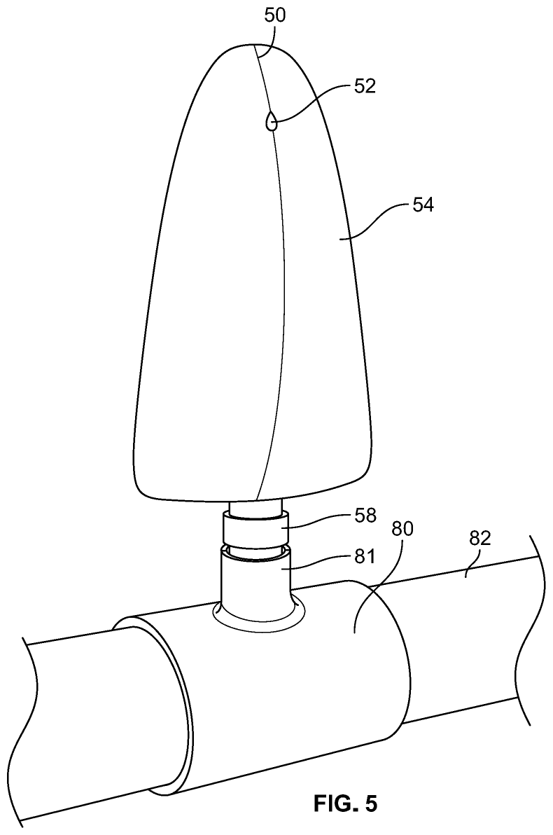

FIG. 3 is a diagram illustrating interior hardware components of the inline monitoring device of FIG. 1. The housing 54 can include a waterproof bladder or a hollow chamber (not shown) that houses a printed circuit board (PCB) 62 having the electronic components of the inline monitoring device 50 mounted thereon or in electrical communication therewith. The bladder can be formed of a plastic material that is resistant to deformation and damage from impact, chemicals, and/or heat. For example, the bladder can be formed of a plastic material such as acrylonitrile butadiene styrene (ABS). The sensors 57 are connected to the PCB 62 via a connection 72, which can comprise wiring between the sensors 57 and a sensor interface 230 (see FIG. 5) mounted on the PCB 62. In addition, a waterproof seal 70 maintains the interior of the housing waterproof

The electronic components housed within the bladder of the inline monitoring device 50 and electrically coupled to the PCB 62 can include, but are not limited to, a processor 208, a memory 210, a wireless Bluetooth™ transceiver 220, an LED indicator 64, an accelerometer 68, a sensor interface 230, a reed switch 66, a gyroscope 74, and a power supply 202, as shown in FIGS. 3 and 5. It is noted that the electronic components can be mounted on the PCB 62 or otherwise positioned within the bladder. Moreover, the electronic components can also include a wired communication subsystem 213, an Ethernet transceiver 215, and/or a serial transceiver 217 (e.g., RS-485, RS-232, USB, etc.) to establish wired communication.

The LED indicator 64 can be mounted on the PCB 62 such that the LED indicator 64 is positioned in line with the aperture 52 of the housing 54. As such, the LED indicator 64 can be viewed from the outside of the inline monitoring device 50 to notify a user that the inline monitoring device 50 is operational while the sensors 57 are submerged in water flowing through the pipe of the pool or spa plumbing system.

The accelerometer 68 can measure acceleration forces applied to the inline monitoring device 50, and the data provided therefrom can be used to determine whether the inline monitoring device 50 is damaged and/or dislodged from the pool or spa plumbing system pipe, e.g., by determined whether an orientation of the inline monitoring device 50 has changed. For example, the data from the accelerometer 68 can be used to determine that an inline monitoring device 50 that was installed perpendicularly to the pipe has become parallel to the pipe. In such a case, the inline monitoring device 50 can transmit a notification to the remote device 100 to notify the user that the inline monitoring device 50 is damaged and/or dislodged from the pipe. Additionally, the accelerometer 68 can alert the inline monitoring device 50 to discard measurements received while the inline monitoring device 50 was damaged and/or dislodged from the pipe as it is likely that the measurements are not accurate or relevant. It is noted that the accelerometer 68 can be used in combination with the gyroscope 74. The accelerometer 68 can also detect vibration energy generated by the pool or spa plumbing system and transmitted through the pipe in order to detect and determine whether the pump is operating and/or water is flowing through the pipes of the pool or spa plumbing system.

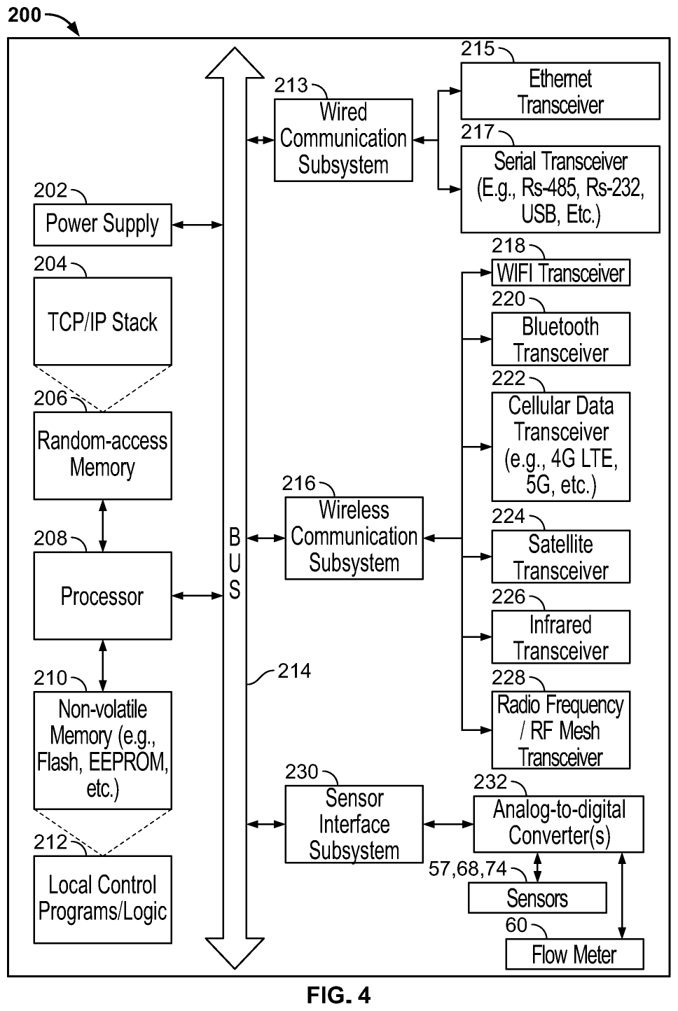

FIG. 4 is a block diagram illustrating components 200 of the inline monitoring device 50 of FIG. 1 in greater detail. The components 200 can be positioned within the inline monitoring device 50 (e.g., within the housing 54 and the waterproof bladder).

A power supply 202 provides the inline monitoring device 50 with power. The power supply 202 can be a rechargeable lithium ion battery. As discussed above in relation to the reed switch 66, the power supply 202 could have ON/OFF capability such that the inline monitoring device 50 could be powered ON when necessary and turned OFF when not in use to prolong battery life.

A processor 208 provides local processing capability for the inline monitoring device 50. The processor 208 is in communication with a random access memory 206, and one or more non-volatile memories 210. The non-volatile memory 210 could store one or more local control programs 212 for providing local control of the inline monitoring device 50. The control programs 212 can be, for example, polling schedules for the sensors. A TCP/IP stack 204 is provided for allowing the inline monitoring device 50 to obtain an Internet protocol address, and to provide Internet connectivity for the inline monitoring device 50. The processor 208 could communicate with a wired communication subsystem 213, a wireless communication subsystem 216 and a sensor interface subsystem 230 by way of a bus 214.

The components 200 allow for a wide variety of wired and wireless connections to the inline monitoring device 50. For example, the wired communication subsystem 213 can communicate with the Ethernet transceiver 215 and the serial transceiver 217. The serial transceiver could support one or more suitable serial communication protocols, such as RS-485, RS-232, USB, etc. The wireless communication subsystem 216 could include a Wi-Fi transceiver 218, a Bluetooth (or Bluetooth LE) transceiver 220, a cellular data transceiver 222, a satellite transceiver 224, an infrared transceiver 226, and a radiofrequency/RF mesh transceiver 228. The cellular data transceiver 222. could support one or more cellular data communications protocols, such as 4G, LTE, 5G, etc. The radiofrequency/RF mesh transceiver 228 could support one or more RF mesh network protocols, such as ZWave, Zigbee, Thread, Weave, etc. Moreover, a remote server or “cloud” platform could connect to the inline monitoring device 50 via the system components 200 to allow for remote and/or web-based control, discussed in greater detail in connection with FIG. 6.

The sensor interface subsystem 230 could include analog connection interfaces, digital connection interfaces, and one or more analog-to-digital converters 232. The sensor interface subsystem 230 allows the network communication and the inline monitoring device 50 to obtain information from a wide variety of sensors 57, 60, 68, 70 associated with the inline monitoring device 50, as well as other types of sensors. In this regard, it should be understood that the other types of sensors are contemplated for integration with the inline monitoring device 50. The wireless communication subsystems 216 allows the network communication and the inline monitoring device 50 to connect via various wireless communication means to the Internet. This allows the inline monitoring device 50 to transmit sensor data and operational and status information to one or more remote devices 100, as well as to be remotely controlled by such devices.

FIG. 5 is a diagram illustrating the inline monitoring device 50 of FIG. 1 coupled to component, e.g., a pipe 82, of a pool or spa plumbing system. As mentioned above, the inline monitoring device 50 comprises the housing 54 and the mounting rod 58, and is configured to be coupled to a pipe 82 of the pool or spa plumbing system such that the inline monitoring device 50 is inline with the pipe 82 and the sensor 57 is exposed to the water within the pipe 82. As seen in FIG. 5, the pipe 82 can include a tee union 80 having a threaded boss 81 configured to receive the threaded portion 56 of the mounting rod 58. An o-ring (not shown) may be positioned on a lip of the threaded boss 81 to provide a watertight seal when the threaded portion 56 is threaded into the threaded boss 81.

As noted above, while FIG. 5 illustrates the inline monitoring device 50 engaged with a pipe 82, it should be understood that the inline monitoring device 50 can be engaged with other components of the pool or spa plumbing system, such as, but not limited to, a pump, a filter, a heater, etc., depending on a user's needs and desires. This installation flexibility allows the inline monitoring device 50 to be installed in different locations depending on ease of installation and desired exposure to pool/spa water circulating through the pool or spa plumbing system. For example, it may be more desirable to engage the inline monitoring device 50 with a component of the pool or spa plumbing system that a user can guarantee will always contain pool/spa water, e.g., even when the pump is off, in order ensure a constant interface between the sensor 57 and the water. Alternatively, it may be desirable to install the inline monitoring device 50 in a different location/component within the pool or spa plumbing system that is not exposed to full velocity water flow, which may otherwise shorten the life of the sensor 57. Still further, the inline monitoring device 50 can be configured to engage pre-existing component connections, e.g., threaded connections, which can reduce installation time and alleviate the need for installation of a special fitting.

The sensor 57 can measure the chemical and environmental characteristics of the pool or spa water at a specified interval (e.g., every 10 milliseconds, every second, every 15 minutes, every hour or once per day) to conserve the power supply 202 of the inline monitoring device 50. The interval frequency can also be adjusted based on a time of day. For example, the sensor 57 can measure the chemical and environmental characteristics of the pool or spa water more frequently (e.g., every 10 minutes) during the day (e.g., between 9 o'clock in the morning and 6 o'clock in the afternoon) when pool or spa utilization is more likely to realize increased variations in the measured chemical and environmental characteristics of the pool or spa water. Similarly, the sensor 57 can measure the chemical and environmental characteristics of the pool or spa water less frequently (e.g., every 60 minutes) during the night (e.g., between 6 o'clock in the afternoon and 9 o'clock in the morning) when pool or spa utilization is less likely to realize less variations in the measured chemical and environmental characteristics of the pool or spa water. It is noted that other measurement intervals are possible. For example, the measurement interval can increase in frequency (e.g., from every 15 minutes to every 5 minutes) when the inline monitoring device 50 observes an increase in measurement fluctuations of the chemical and environmental characteristics of the pool or spa water by the sensor 57.

The reed switch 66 is an electrical switch and controls an energization of the inline monitoring device 50. The reed switch 66 can be in a conducting state (i.e., an ON state) or a non-conducting state (i.e., an OFF state) based on the presence of a magnetic field that is different from the Earth's magnetic field and applied to the reed switch 66. For example, the reed switch 66 can in the OFF state in the presence of a magnetic field generated by a magnet and in the ON state when the magnetic field (i.e., the magnet) is removed or vice versa. The reed switch 66 can function as a user input device in lieu. of one or more push buttons positioned on an exterior of the housing 54 of the inline monitoring device 50. This is advantageous because a push button to energize the inline monitoring device 50 is prone to water damage.

It is noted that the inline monitoring device 50 can be shipped in a shipping box. The shipping box can include a magnet that is positioned near the reed switch 66 when the inline monitoring device 50 is positioned inside the shipping box. When the inline monitoring device 50 is positioned inside the shipping box, the magnet can turn OFF the reed switch 66 and the PCB 62 such that electricity is not drawn from the power supply. As such, the power supply is conserved during the shipping of the inline monitoring device 50. When a user removes the inline monitoring device 50 from the shipping box, the reed switch 66 and the PCB 62 are turned ON such that the electronic components of the inline monitoring device 50 are also turned ON.

A user can also position the inline monitoring device 50 inside the shipping box and remove it therefrom to reset the electronic components of the inline monitoring device 50. For example, the user can position the inline monitoring device 50 inside the shipping box near the magnet for a specified time period (e.g., 10 seconds) and then remove the inline monitoring device 50 from the shipping box to erase the content stored in the memory 210 of the inline monitoring device 50. The user can also position the inline monitoring device 50 inside the shipping box to turn OFF the electronic components thereof when the inline monitoring device 50 is not being utilized (e.g., during the winter).

The magnet can be provided as a separate element which can be removed from the shipping box such that the user can discard the shipping box while also utilizing the magnet to activate and deactivate the reed switch 66. As such, the inline monitoring device 50 can be turned ON, turned OFF, and reset without an external switch or push button that can jeopardize the waterproof integrity of the inline monitoring device 50.

The inline monitoring device 50 can also comprise a voltage meter for measuring stray voltage within the pool or spa water. For example, if the wiring of a pump, light fixture or other source of electrical current were in contact with the pool or spa water, stray current may be present thereby creating a hazard to a user of the pool or spa. In such an event, the inline monitoring device 50 can cause the LED indicator 64 to flash or trigger an alarm warning to alert the user that the pool or spa is not safe to enter. Additionally, the inline monitoring device 50 can transmit a notification to the remote device 100 to notify a user who is not proximate to the pool or spa (e.g., a parent at work).

FIG. 6 is a diagram illustrating an inline monitoring device system 300. In the system 300, a server system 118 provides functions for managing a plurality of inline monitoring devices 50a, 50b and 50c. The server system 118 comprises software components and databases that can be deployed in one or more datacenters 116 located in one or more geographical locations. The server system 118 software components comprise a device manager 120, an analytics engine 122, a calculation engine 124, a notification engine 126, and an inventory engine 128. The server system 118 databases comprise a device data database 130, an inventory data database 132, and an actions database 134. The databases 130, 132, 134 can reside in one or more physical storage systems.

The inline monitoring devices 50a, 50b, 50c illustrated in FIG. 6 can each be the inline monitoring device 50 discussed in connection with FIGS. 1-5 and the remote devices 100a, 100b, 100c illustrated in FIG. 6 can each be the remote device 100 described in connection with FIG. 2. Each of the inline monitoring devices 50a, 50b, 50c can be respectively connected to a remote device 100a, 100b, 100c (e.g., via a respective Bluetooth™ connection) of a user 104a, 104b, 104c. The remote devices 100a, 100b, 100c can include, but are not limited to, a smart telephone, a tablet, a wearable (e.g., a smart watch), a personal digital assistant, a laptop and a computer. The remote devices 100a, 100b, 100c can each communicate with the server system 118 through one or more data communication networks 114, such as the Internet. The inline monitoring devices 50a, 50b, 50c can also respectively communicate with server system 118 through routers 110a, 110b, 110c and the one or more data communication networks 114. As noted above, the inline monitoring device 50 can also be configured to wirelessly connect directly to an infrastructure component (e.g., a gateway or a cell tower) for connection to the Internet by way of a LoRalWAN® connection or a cellular connection. The inline monitoring devices 50a, 50b, 50c can be respectively installed proximate to or remote from a pool or spa 106a, 106b, 106c so long as they are installed in a pipe of the pool or spa plumbing system that is operatively connected to pool or spa pumps 108a, 108b, 108c.

As previously discussed, each client application 102a, 102b, 102c can run on a remote device 100a, 100b, 100c and can generate and display a graphic user interface 101a, 101b, 101c on the remote device 100a, 100b, 100c. Each graphic user interface 101a, 101b, 101c is configured to display characteristics of the pool or spa water, and notifications indicative of pool or spa chemical levels and/or user actions based on the identified pool or spa chemical levels. For example, each client application 102a, 102b, 102c can facilitate the selection of monitoring parameters such that the inline monitoring devices 50a, 50b, 50c monitor and transmit measurements at defined intervals (e.g., daily or hourly) or, in some instances, on a continual basis.

The remote devices 100a, 100b, 100c can store and/or relay respective measurement data from the inline monitoring devices 50a, 50b, 50c to the device manager 120 of the server system 118. Additionally and/or alternatively, the inline monitoring devices 50a, 50b, 50c can transmit respective measurement data via the network 114 to the device manager 120 of the server system 118. The device manager 120 can store the measurement data in the device database 130. The server system 118 can determine the monitoring characteristics and notifications to be displayed to a user 104a, 104b, 104c based on the measurement data. The client applications 102a, 102b, 102c can each display the determined monitoring characteristics and notifications via the respective graphic user interfaces 101a, 101b, 101c displayed on the remote user devices 100a, 100b, 100c.

Alternatively, bridge devices (e.g., routers 110a, 110b, 110c) can relay respective measurement data from the inline monitoring devices 50a, 50b, 50c to the device manager 120 of the server system 118. The routers 110a, 110b, 110c can be respectively connected to the inline monitoring devices 50a, 50b, 50c via a WiFi or Bluetooth™ connection. In this way, measurement data can he more reliably relayed to the server system 118 in the event that the remote devices 100a, 100b, 100c lose their respective connections to the inline monitoring devices 50a, 50b, 50c (e.g., when the remote devices 100a, 100b, 100c are not located within wireless communication range of the devices 50a, 50b, 50c). It is noted that the routers 110a, 110b, 100c can also be respectively connected to the inline monitoring devices 50a, 50b, 50c via a wired connection (e.g., Ethernet, RS-485, RS-232, USB, etc.).

The remote devices 100a, 100b, 100c may annotate measurement data with at least one image of the pool or spa or another indicator of a state of the pool or spa water. The images can be synchronized with measurement data based on timestamps electronically associated with the images and the measurement data to increase an accuracy of the measurements.

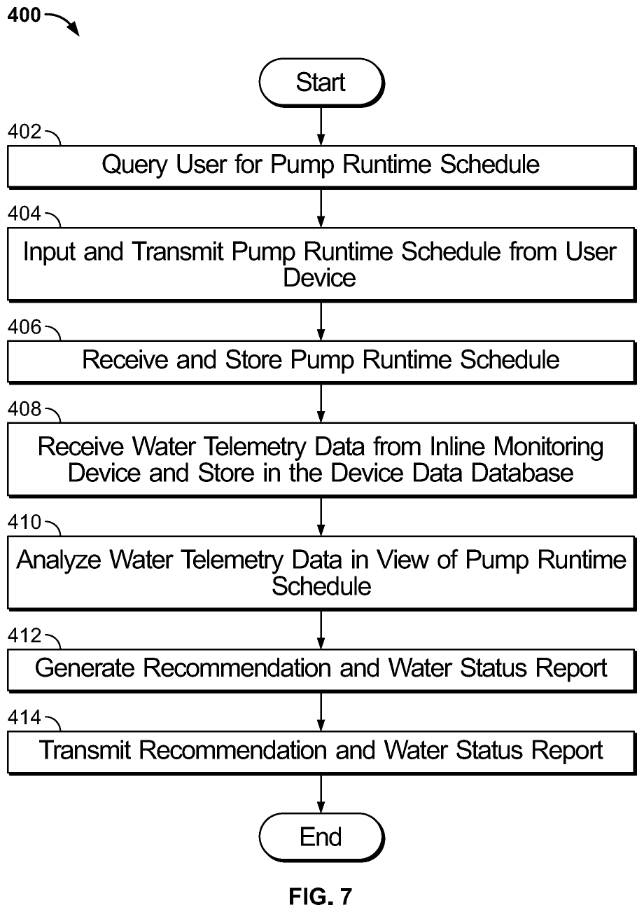

The analytics engine 122 can determine when the pool or spa pump is active based on at least one of a pool or spa pump runtime schedule received from a remote user device 100, the pool or spa water measurement data (i.e., telemetry data) transmitted from the inline monitoring device 50, and pool or spa vibration energy data transmitted from the inline monitoring device 50. The features and operations of the analytics engine will be discussed in further detail below in connection with FIGS. 7-15.

The calculation engine 124 is a software component that is configured to calculate an amount of a particular chemical to be applied to the pool or spa based on the measurement data. received from the inline monitoring device 50. In addition, the calculation engine 124 can determine a user action corresponding to the calculated amount of the particular chemical to be applied to the pool or spa. For example, based on the measurement data received from the inline monitoring device 50, the calculation engine 124 can determine a user action to instruct a user to add one red pod to the pool or spa. The device manager 120 can transmit a notification including the user action to the remote user device 100a, 100b, 100c to be displayed on the graphic user interface 101a, 101b, 101c generated by the client application 102a, 102b, 102c.

Rather than transmit individual user action notifications whenever a new user action is determined by the calculation engine 124, the server system 118 can combine several user actions in one notification and transmit the notification to the remote user device 100. In particular, the calculation engine 124 can store each determined user action in the actions database 134, and subsequently the notification engine 126 can bundle the stored determined user actions for a particular user and transmit a notification including the bundled determined user actions to the remote user device 100a, 100b, 100c to be displayed on the graphic user interface 101a, 100b, 100c generated by the client application 102a, 102b, 102c.

The calculation engine 124 can also measure or predict the actual impact on the pool or spa and/or determine the volume of water in the pool or spa based on an expected impact (e.g., a change in a measured characteristic of the pool or spa water) of the amount of a particular chemical applied to a given volume of pool or spa water and measured characteristics of the pool or spa water by the inline monitoring device 50 after the amount of the particular chemical is applied to the pool or spa. This can be accomplished in accordance with the disclosure of U.S. Pat. No. 9,834,451 filed on Mar. 16, 2017 and entitled “Chemical Monitoring Devices and Methods,” previously incorporated herein by reference,

The inventory engine 128 tracks an inventory of chemical pods stored in the inventory data database 132. A starting inventory of chemical pods can be included with the inline monitoring device 50 upon the shipment thereof. For example, the starting inventory of chemical pods can include, but is not limited to, 12 red pods, 8 blue pods, 6 green pods, and 4 yellow pods and can be stored in the inventory data database 132. If the server system 118 transmits a notification to the user including a user action to apply a particular number of a particular chemical pod (e.g., 2 red pods) to the pool or spa, the inventory engine 128 subtracts the particular number of the particular chemical pod from the user's inventory record stored in the inventory data database 132. In addition, when a particular number of chemical pods are shipped to a user (e.g., 3 blue pods and 3 green pods), the inventory engine 128 adds the particular number of chemical pods to the user's inventory record stored in the inventory data database 132.

The inventory engine 128 can also calculate in advance (e.g., one or two months in advance) a particular number of a particular chemical pod required by the user based on one or more of the user's inventory record stored in the inventory data database 132, past chemical pod usage (i.e., historical data), and geographic location. Further, based on the calculation, the inventory engine 128 can request that a supplier ship the particular number of the particular chemical to the user or transmit a notification to the remote user device 100 for authorization before requesting a shipment of the particular number of the particular chemical from the supplier.

The server system 118 can also identify potential problems based on the measurement data provided by the inline monitoring device 50 and in the device data database 130, and transmit a notification to the remote user device 100 that includes a user action to address the identified problem. For example, the user action can direct a user to replenish water to the pool or spa up to a predetermined water level if the server system 118 identifies that the pool or spa has lost water due to evaporation or leakage (e.g., a crack on a side or bottom of the pool or spa). The server system 118 can also identify a potential leakage problem of a particular pool or spa based on measurement data received from other inline monitoring devices 50 being utilized in the vicinity (e.g., within a file mile radius) of the particular pool or spa. For example, the server system 118 can determine whether the chemicals in the particular pool or spa have diluted faster than chemicals in a neighboring pool or spa. which would see a. similar level of evaporation.

The server system 118 can also store records of a service network of certified pool or spa technicians to facilitate delegating pool or spa maintenance tasks, consistent with the disclosure of U.S. Pat. No. 9,834,451 filed on Mar. 16, 2017 and entitled “Chemical Monitoring Devices and Methods,” previously incorporated herein by reference.

The server system 118 can store in the device data database 130 and in the actions data database 134 information and actions associated with each inline monitoring device 50a, 50b, 50c. For example, the server system can store, for each inline monitoring device 50a, 50b, 50c, a location, an action status, a service request, user actions to be performed and a user action history. It is noted that the server system 118 can also store other types of information and actions associated with each inline monitoring device 50a, 50b, 50c.

The server system 118 and calculation engine 124 can also utilize the measurement data transmitted from the inline monitoring device 50 and stored in the device data database 132 to identify trends for a pool or spa, neighborhoods, or larger demographic areas, consistent with the disclosure of U.S. Pat. No. 9,834,451 filed on Mar. 16, 2017 and entitled “Chemical Monitoring Devices and Methods,” previously incorporated herein by reference.

The trend data can be used to build protocols that represent higher-order treatment routines which can be attributed to a particular pool or spa. For example, a protocol can be derived that represents a 25,000-30,000 gallon pool with over 75% sun exposure and moderate use in a certain geographic zone. A pool or spa can be assigned to a geographic zone based on one or more of a latitude/longitude pair, a zip code and an agricultural zone such as the plant hardiness zone map. The protocol can then be assigned to a new pool as it is added to the service such that limited or no data need be collected before scheduling a treatment regimen. Protocols can also be utilized to identify outlier characteristic measurements of the pool or spa water or to initiate actions when the inline monitoring device 50 is inactive.

FIG. 7 is a flowchart illustrating processing steps 400 of an embodiment of the present disclosure for monitoring and measuring characteristics of a pool or spa which takes into account a pump runtime schedule. As explained above, monitoring and measuring characteristics of pool or spa water in a pool or spa plumbing system can be challenging because the pool or spa water in the plumbing system can become stagnant and be affected by environmental factors at a different rate compared to water in the pool or spa body when the pool or spa pump is not running. Accordingly, it is important to detect and/or determine when the pool or spa pump is running and consider these periods of operation and inoperation when evaluating measurement readings to more accurately monitor the pool or spa water flowing through the pool or spa plumbing system,

In step 402, a user is requested to input the pool or spa pump runtime schedule. In step 404, a user inputs the pool or spa pump runtime schedule into the remote user device 100 via the client application 102 graphic user interface 101 displayed on the remote user device 100, which transmits the pool or spa pump runtime schedule to the server system 118. In step 406, the server system 118 receives the pool or spa pump runtime schedule from the remote device 100 and stores the pool or spa pump runtime schedule in the device data database 130. Alternatively or additionally, the remote user device 100 can transmit the pool or spa pump runtime schedule to the inline monitoring device 50. The pool or spa pump runtime schedule can he stored locally by the processor 208 of the inline monitoring device 50 in the non-volatile memory 210. It is noted that the pool or spa runtime schedule can be transmitted by the remote user device 100 or the inline monitoring device 50 to the server system 118.

Then, in step 408, the server system 118 receives the pool or spa water telemetry data (i.e., measurement data) from the inline monitoring device 50, e.g., measured by the sensor 57 thereof, and stores the received pool or spa water measurement data in the device data database 130. The measurement data can include, but is not limited to, the pool or spa water pH, ORP, and temperature and is timestamped as collected. It should he understood that the inline monitoring device 50 can continuously poll the sensors 57 and transmit the measurement data to the server system 118, or can poll the sensors 57 based on a schedule and transmit the measurement data on the same schedule. Alternatively, the measurement data can he transmitted in blocks instead of continuously.

In step 410, the server system 118, e.g., the analytics engine 122, analyzes the measurement data in view of the pool or spa pump runtime schedule to determine whether the measurement data was collected while the pool or spa pump was running. That is, the server system 118 determines the measurement data that should he utilized and the measurement data that should be discarded. Next, in step 412, the server system 118, e.g., the calculation engine 124, generates a recommendation and pool or spa water status report based on the analyzed measurement data. Lastly, in step 414, the server system 118 transmits the generated recommendation and pool or spa water status report to the remote user device 100. It is noted that the report can include, but is not limited to, a chemical level of the pool or spa water, a clarity level of the pool or spa water, and a hardness level of the pool or spa water. The report can also include instructions for the user to add chemicals, e.g., color coded chemical pods, to the pool or spa. Additionally, the server system 118 can transmit instructions to autonomously turn on pool/spa equipment as needed based on the calculations, recommendations, and/or report. For example, if the server system 118 determines that the water's pH is too high, then the server system 118 can send an instruction to turn on the pump and activate an acid feeder, if one is installed in the user's pool/spa system, to lower the water's pH without the need for user action. As another example, upon instructing a user to add chemicals, the server system 118 can also automatically turn on an associated pump for a certain period of time to ensure that the chemicals added to the water by the user adequately disperse throughout the body of water. It is additionally contemplated by the present disclosure that other pool/spa equipment can also he controlled by system including, but not limited to, pumps, salt water generators, acid feeders, heaters, pool cleaners, etc.

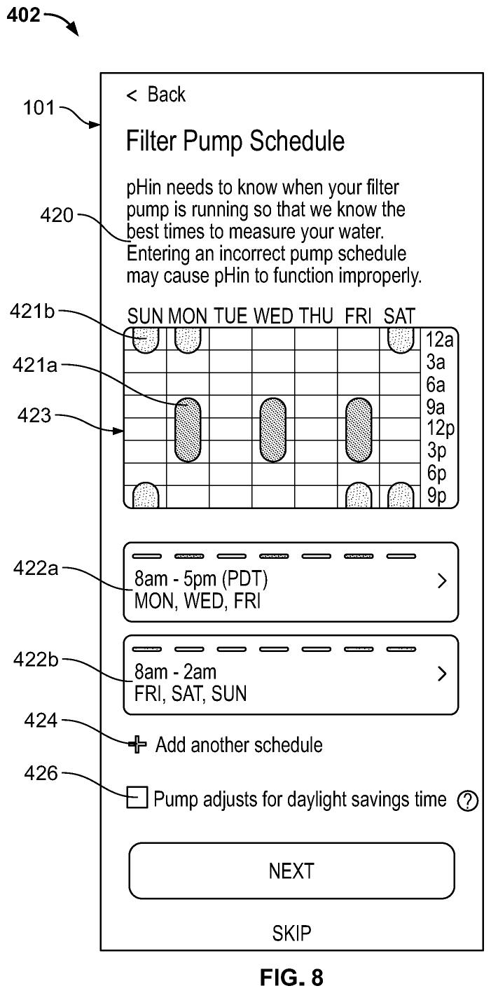

FIG. 8 is a diagram illustrating the client application 102 graphic user interface 101 associated with Step 404 of FIG. 7 for inputting the pool or spa pump runtime schedule. The graphic user interface 101 can include, for example, a prompt 420, a scheduling calendar graphic 423 including pool or spa pump runtime blocks 421a, 421b respectively corresponding to pool or spa pump runtime schedules 422a, 422b, an add schedule function 424, and a daylight savings adjust function 426.

As shown in FIG. 8, a user can input one or more pool or spa pump runtime schedules via the add schedule function 424 and can adjust the one or more pool or spa runtime schedules for daylight savings time via the daylight savings adjust function 426. For example, a user can add another pool or spa pump runtime schedule by clicking the add schedule function 424. In addition, a user can modify the pool or spa pump runtime schedules 422a, 422b for specific days of the week by clicking into each one of the pool or spa pump runtime schedules. The add schedule function 424 allows for one or more pool or spa pump runtime schedules to be input to account for the programming of multiple pool or spa pump runtime schedules. In addition, when the daylight savings adjust function 426 is selected, the application will adjust the schedules to account for daylight savings time in the pool or spa location.

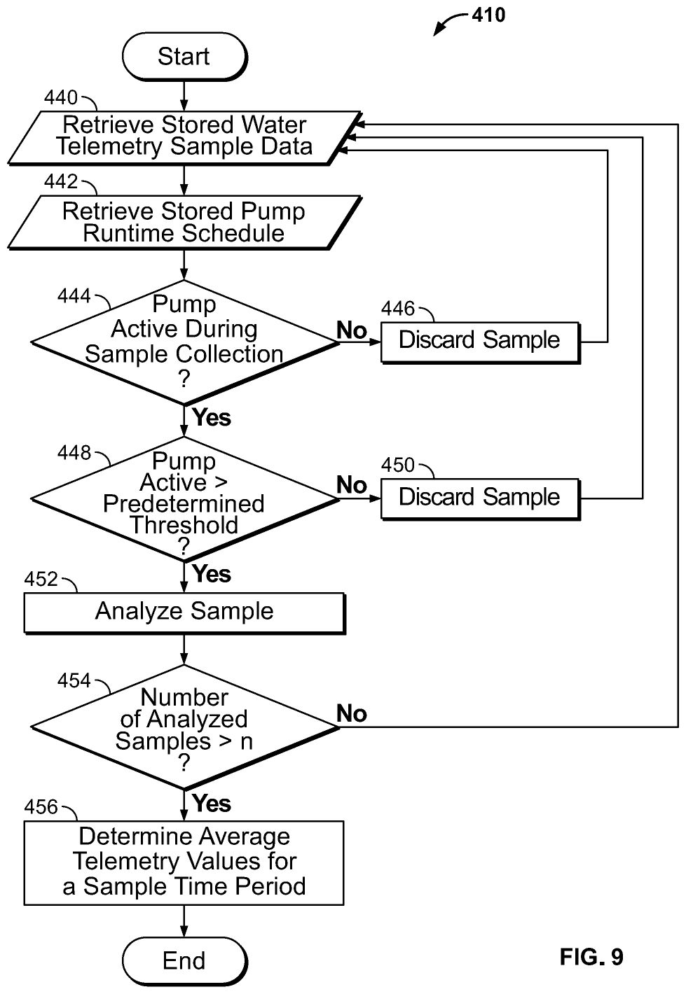

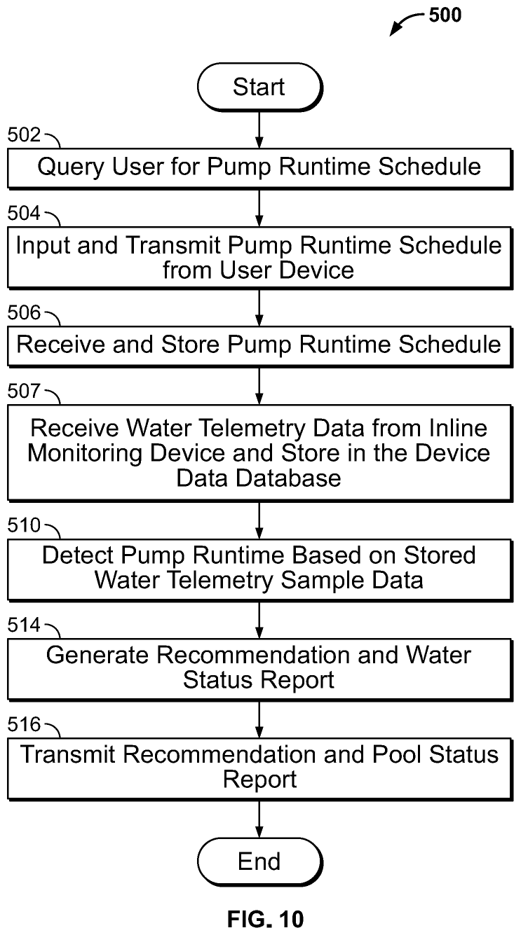

FIG. 9 is a flowchart illustrating Step 410 of FIG. 7 in greater detail. The analytics engine 122 of the server system 118 can determine when the pool or spa pump is running based on at least one of the stored pool or spa pump runtime schedule and the stored measurement data. Beginning in step 440, the analytics engine 122 retrieves stored measurement data, e.g., a single data point, from the device data database 130. It is noted that the stored measurement data can he indicative of when the pool or spa pump is or is not running, which is discussed in greater detail in connection with FIGS. 10-12.

Next, in step 442, the analytics engine 122 retrieves the stored pool or spa pump runtime schedule from the device data database 130, e.g., the schedule transmitted in step 404 of FIG. 7. It is noted that the analytics engine 122 can also convert the pool or spa pump runtime schedule(s) into a week-long schedule to account for rollover time periods when the pool or spa pump runtime schedule(s) runs past midnight.

In step 444, the analytics engine 122 determines whether the pool or spa pump was running at the time that the sample measurement data was collected. This is done by comparing the pool or spa pump runtime schedule with the timestamps associated with the sample measurement data. If it is determined that the pool or spa pump was not running during collection of the sample measurement data, then in step 446 the sample is discarded and the process returns to step 440 to retrieve another sample of the stored measurement data. If it is determined that the pool or spa pump was running during the collection of the sample measurement data then the process proceeds to step 448.

In step 448, the analytics engine 122 determines whether the pool or spa pump was running for a time period longer than a predetermined threshold when the sample measurement data was collected. For example, the analytics engine 122 can determine whether the pool or spa pump was running for a time period longer than 30 minutes after a pool or spa pump runtime ON event (i.e., after an initiation of the pool or spa pump), or was running for more than 30 minutes prior to collection of the data measurement. This is to ensure that the sample measurement data is representative of the whole body of pool or spa water and not just a different part of the pool or spa plumbing system. If the pool or spa pump was not running for a time period longer than the predetermined threshold when the sample measurement data was collected, then in step 450 the sample is discarded and the process returns to step 440 to retrieve another sample of the stored measurement data. If the pool or spa pump was running for a time period longer than the predetermined threshold when the sample measurement data was collected, then the process proceeds to step 452.

In step 452, the analytics engine 122 analyzes the sample measurement data to filter out nuisance values and/or noise. For example, the analytics engine 122 may leverage a data pre-processing technique, such as data binning, to filter data outliers (e.g., data spikes). Once the data sample is confirmed, the process proceeds to step 454 wherein the analytics engine 122 determines whether a number of analyzed samples of measurement data is greater than a minimum integer value n. If the number of analyzed samples of measurement data is not greater than the minimum integer value n, then the process returns to step 440 to retrieve another sample of the stored measurement data. If the number of analyzed samples of the measurement data is greater than the minimum integer value n, then the process proceeds to step 456.

In step 456, the analytics engine 122 determines average telemetry values for the analyzed samples of measurement data for a sample time period. For example, the analytics engine 122 can determine average pH, ORP, and temperature values for the analyzed samples of measurement data for a sample period including, but not limited to, a specified number of hours or a time period since the pool or spa pump runtime ON event as per the schedule. These values are utilized to generate the recommendation and water status report in step 412 of FIG. 7 that is transmitted to the remote user device 100. It is noted that the report can include, but is not limited to, a chemical level of the pool or spa water, a clarity level of the pool or spa water, and a hardness level of the pool or spa water.

Additionally, as described above, the server system 118 can transmit instructions to autonomously turn on pool/spa equipment as needed based on the calculations, recommendations, and/or report.

FIG. 10 is a flowchart illustrating processing steps 500 of another embodiment of the present disclosure for monitoring and measuring characteristics of a pool or spa, which takes into account variations in measurement data.

In step 502, a user is requested to input the pool or spa pump runtime schedule, In step 504, a user inputs the pool or spa pump runtime schedule into the remote user device 100 via the client application 102 graphic user interface 101 displayed on the remote user device 100, which transmits the pool or spa pump runtime schedule to the server system 118. In step 506, the server system 118 receives the pool or spa pump runtime schedule from the remote device 100 and stores the pool or spa pump runtime schedule in the device data database 130. Alternatively or additionally, the remote user device 100 can transmit the pool or spa pump runtime schedule to the inline monitoring device 50. The pool or spa pump runtime schedule can be stored locally by the processor 208 of the inline monitoring device 50 in the non-volatile memory 210. It is noted that the pool or spa runtime schedule can be transmitted by the remote user device 100 or the inline monitoring device 50 to the server system 118.

Then, in step 507, the server system 118 receives the pool or spa water telemetry data (i.e., measurement data) from the inline monitoring device 50, e.g., measured by the sensor 57 thereof and stores the received pool or spa water measurement data in the device data database 130. The measurement data can include, but is not limited to, the pool or spa water pH, ORP and temperature and is timestamped as collected. It should be understood that the inline monitoring device 50 is continuously polling the sensor 57 and transmitting the measurement data to the server system 118.

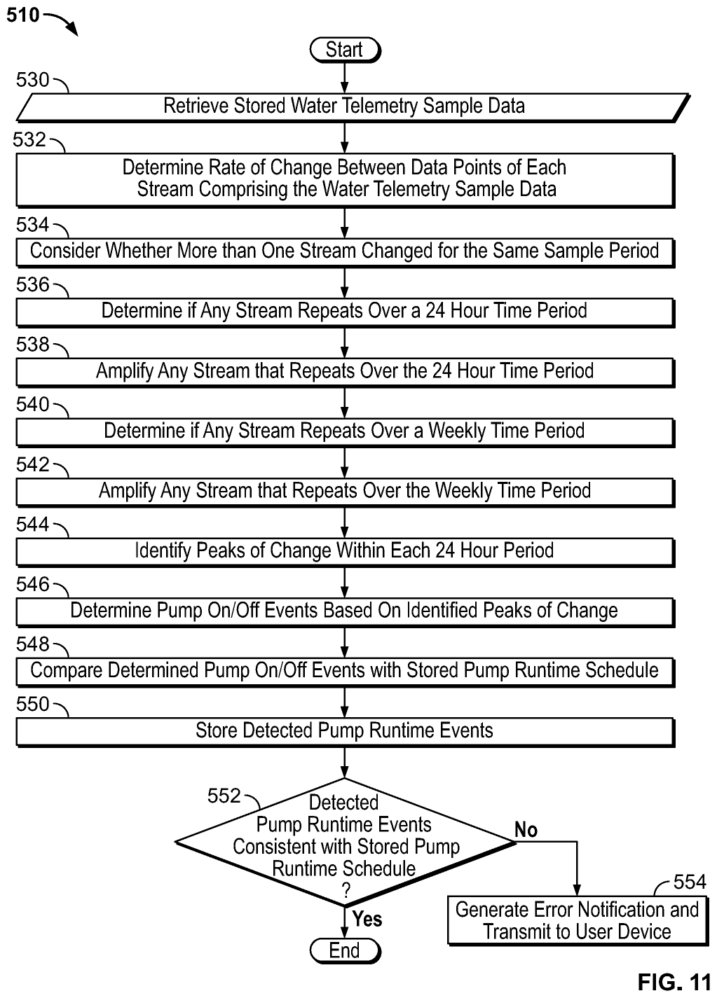

In step 510, the server system 118 detects a pool or spa pump runtime based on stored streams of pool or spa water sample telemetry data, which is discussed in greater detail in connection with FIG. 11. The streams of pool or spa water sample telemetry data can be stored in the device data database 130, and can span at least seven days to most effectively detect the pool or spa pump runtime. Thereafter, every seven days the server system 118 can compute the pool or spa. pump runtime for the past seven days and store a history of previously detected pool or spa pump runtimes in the device data database 130. Next, in step 514, the server system 118, e.g., the calculation engine 124, generates a recommendation and a pool or spa water status report based on the analyzed streams of pool or spa water sample telemetry data. Lastly, in step 516, the server system 118 transmits the generated recommendation and pool or spa water status report to the remote user device 100. It is noted that the report can include, but is not limited to, a chemical level of the pool or spa water, a clarity level of the pool or spa water, and a hardness level of the pool or spa water.

Additionally, as described above, the server system 118 can transmit instructions to autonomously turn on pool/spa equipment as needed based on the calculations, recommendations, and/or report.

FIG. 11 is a flowchart illustrating Step 510 of FIG. 10 in greater detail. The analytics engine 122 of the server system 118 can determine when the pool or spa pump is running based on the stored streams of pool or spa water sample telemetry data. Beginning in step 530, the analytics engine 122 retrieves a sample of the stored streams of pool or spa water sample telemetry data from the device data database 130. It is noted that the stored streams of pool or spa water telemetry data can include, but are not limited to, pH, ORP, and temperature.

In step 532, the analytics engine 122 determines a rate of change between data points of each data stream comprising the pool or spa water sample telemetry data. In particular, for each data stream, e.g., for pH, ORP, and temperature, the analytics engine 122 determines the slope between all successive data points for the same sample period. Then, the analytics engine 122 divides each determined slope by the respective stream's average value, and squares the output to receive an output value for each sample time. In step 534, the analytics engine 122 considers whether more than one stream has changed for the same sample period by analyzing across all of the data streams. In particular, the analytics engine 122 sums the output values of each stream (e.g., the sample value for pH, the sample value for ORP, and the sample value for temperature) from the same sample time to exploit the fact that pool or spa pump runtime ON and OFF events impact all streams simultaneously. This essentially boosts the sample times where more than one sample stream has changed.

Next, in step 536, the analytics engine 122 determines if any data streams repeat over a 24 hour time period, and in step 538 amplifies those streams determined to repeat over a 24 hour time period by convolving the summed output values for each stream with a 24 hour periodic function. This operation accounts for and leverages the fact that pool or spa pump runtime schedules generally repeat every 24 hours. Next, in step 540, the analytics engine 122 determines if any signals repeat over a weekly time period, and in step 542 amplifies those streams determined to repeat over a weekly time period by convolving the output values for each stream from step 538 with a function that amplifies values based on the values from an integer value N previous weeks. That is, the analytics engine 122 looks at past weeks and amplifies those values that have repeated between weeks. This operation accounts for and leverages the fact that a user does not generally modify the pool or spa pump runtime schedule on a daily basis, and therefore the convolution will amplify values that occur at the same time each day and week. It is noted that in some instances a spa pump nintime schedule can be daily scheduled, as opposed to weekly scheduled. As such, the analytics engine 122 can determine if any rate of change for a smaller time period than twenty-four hours (e.g., time periods of four, six, eight, or twelve hours) repeated over several days, in order to account for the twice-daily or thrice-daily schedules of a spa pump controller. Moreover, the analytics engine 122 can also amplify any rate of change that is determined to have repeated over the smaller time periods and determine if any rate of change repeated over a forty-eight, seventy-two, and/or ninety-six hour time period rather than over the weekly time period.

In step 544, the analytics engine 122 identifies peaks of change within each 24 hour time period by determining a local maxima for each of the output values determined in step 542. Peaks of change can be identified in this way because a pool or spa pump runtime schedule generally repeats over a 24 hour time period, and this operation isolates the peaks on different days. Then, in step 546, the analytics engine 122 determines the pool or spa pump ON/OFF events based on the identified peaks of change by converting the identified peaks into pool or spa pump ON/OFF events with timestamps. Next, in step 548, the analytics engine 122 compares the determined pool or spa pump ON/OFF events with the stored pool or spa pump runtime schedule to detect the pool. or spa pump ON/OFF events, if a schedule is available. In step 550, the detected pool or spa pump ON/OFF events are stored in the device data database 130. In particular, an integer value N indicative of the most recent pump ON/OFF events are stored and can be utilized in step 542.

Lastly, in step 552, the analytics engine 122 determines whether the detected pool or spa pump ON/OFF events are consistent with the stored pool or spa pump runtime schedule to identify error scenarios or to replace the user entered pool or spa pump runtimes with the detected pool or spa pump ON/OFF events. If the detected pool or spa pump ON/OFF events are consistent with the stored pool or spa pump runtime schedule, then the process ends. However, if the detected pool or spa pump ON/OFF events are not consistent with the stored pool or spa runtime schedule, then the process proceeds to step 554 and the analytics engine 122 generates and transmits an error notification to the remote user device 100. The error notification can be indicative of the incongruence between the detected pool or spa pump ON/OFF events and the stored pool or spa pump runtime schedule, and can include a recommendation to utilize the detected pool or spa pump ON/OFF events in analyzing future streams of water telemetry sample data. It is noted that if a pool or spa runtime schedule is not stored then steps 548, 552 and 554 can be omitted.

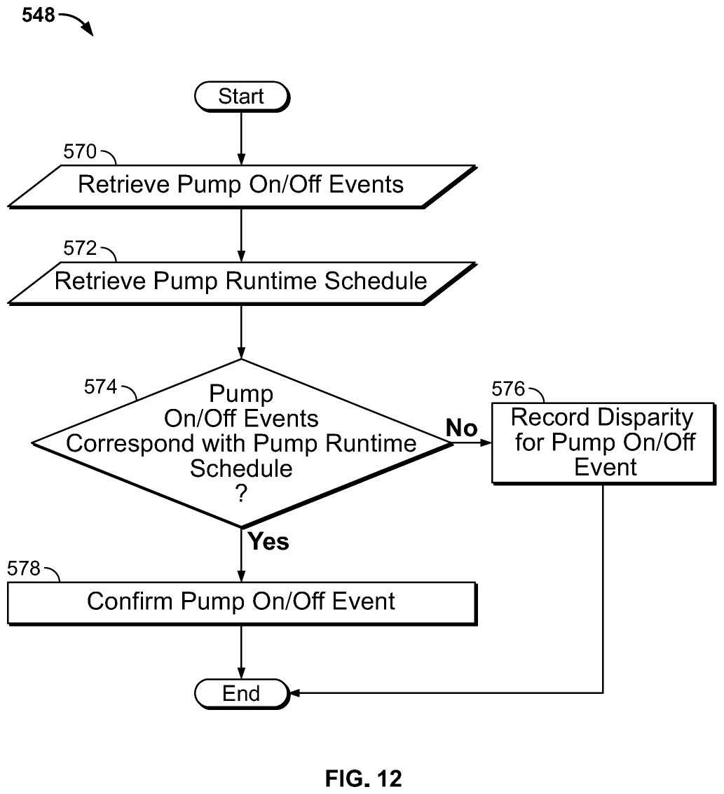

FIG. 12 is a flowchart illustrating Step 548 of FIG. 11 in greater detail. Beginning in step 570, the analytics engine 122 retrieves the pump ON/OFF events determined in step 546 of FIG. 11. In step 572, the analytics engine 122 retrieves the pool or spa pump runtime schedule. In step 574, the analytics engine 122 determines whether the determined pool or spa pump ON/OFF events match up with the pool or spa pump runtime schedule that is stored. This is done by comparing the pool or spa pump runtime schedule with the timestamps associated with the pump ON/OFF events. If it is determined a pump ON/OFF event does not coincide with the saved pool or spa pump runtime schedule, then in step 576 the analytics engine 122 records a disparity for the pool or spa pump ON/OFF event and the process ends. If it is determined that a pump ON/OFF event does coincide with the saved pool or spa pump runtime schedule, then in step 578 the analytics engine confirms or amplifies that event.

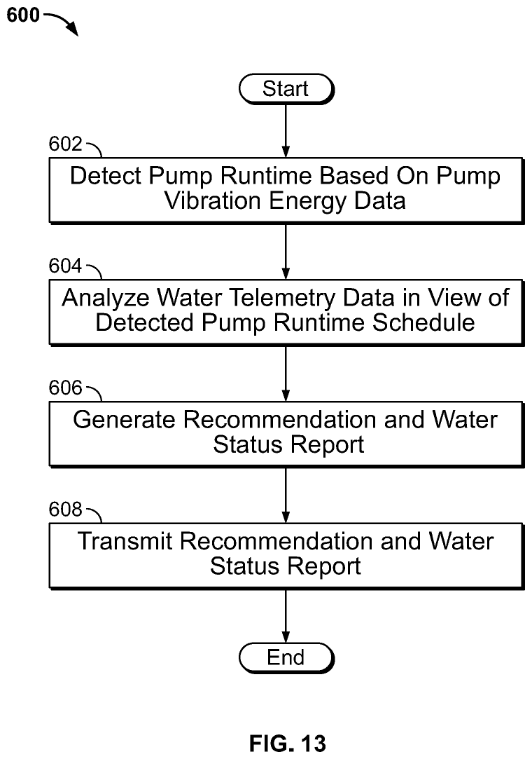

FIG. 13 is a flowchart illustrating processing steps 600 of another embodiment of the present disclosure for monitoring and measuring characteristics of a pool or spa and taking into account accelerometer data.

Another approach for detecting and determining when the pool or spa pump is running is utilizing vibration energy data recorded by the accelerometer 68 of the inline monitoring device 50. The accelerometer 68 can detect vibration energy generated by the pool or spa system, e.g., by the pool or spa pump, and transmitted through the pipe in order to detect and determine whether the pump is operating and/or water is flowing through the pipes thereof It is noted that the accelerometer 68 can be a combination of an accelerometer 68 and a gyroscope 74. Moreover, the accelerometer 68 could be positioned directly on a pipe as opposed to in the inline monitoring device 50. It is also noted that the vibration energy can be utilized independently or in conjunction with a user entered pool or spa pump runtime schedule.

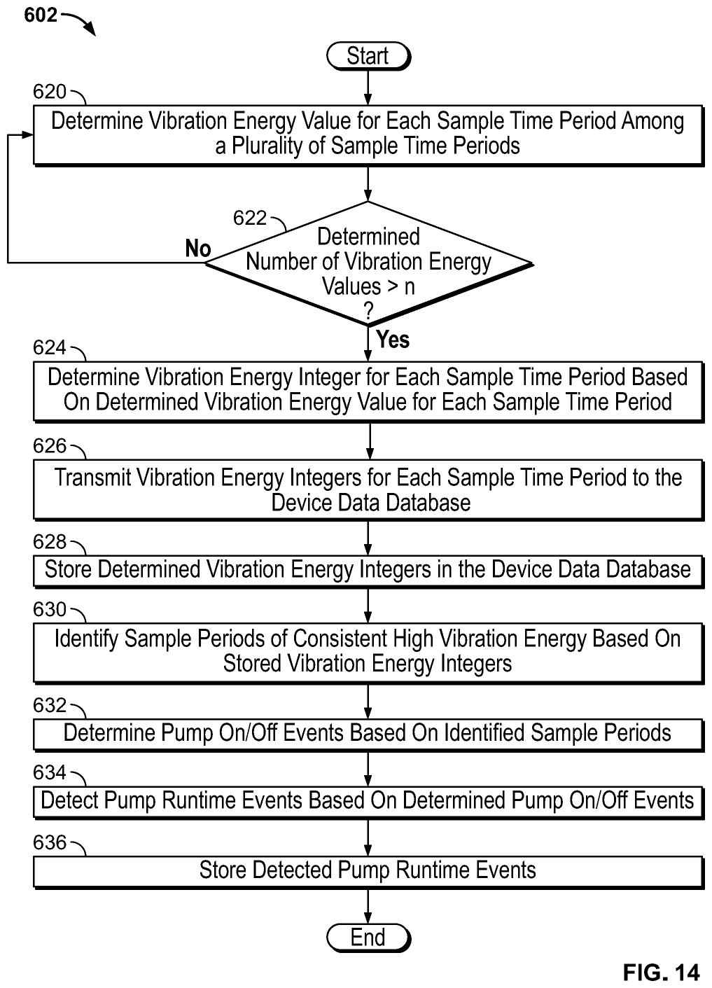

Beginning in step 602,the server system 118 detects the pool or spa pump runtime based on the vibration energy data, e.g., axial acceleration, detected by the accelerometer 68 of the inline monitoring device 50, which is discussed in greater detail in connection with FIG. 14. Then in step 604, the server system 118 analyzes pool or spa water telemetry data in view of the pool or spa pump runtime schedule detected in step 602 to determine whether the sample pool or spa water telemetry data was collected while the pool or spa pump was running. In step 606, the server system 118 generates a recommendation and a pool or spa water status report based on the analyzed sample pool or spa water sample telemetry data. It is noted that the report can include, but is not limited to, a chemical level of the pool or spa water, a clarity level of the pool or spa water, and a hardness level of the pool or spa water. Lastly, in step 608, the server system 118 transmits the generated recommendation and the pool or spa water status report to the remote user device 100.

Additionally, as described above, the server system 118 can transmit instructions to autonomously turn on pool/spa equipment as needed based on the calculations, recommendations, andior report.

FIG. 14 is a flowchart illustrating step 602 of FIG. 13 in greater detail, wherein the analytics engine 122 of the server system 118 determines when the pool or spa pump is running based on the vibration energy data detected by the accelerometer 68 of the inline monitoring device 50. Beginning in step 620, the inline monitoring device 50 determines a vibration energy value for each sample time period among a plurality of sample time periods. In particular, the inline monitoring device 50 sums the squares of the acceleration force detected by the accelerometer in each axis (i.e., the x, y, and z axes) over each sample time period. It is also noted that the accelerometer 68 can detect linear displacement, rotational displacement, linear velocity, and rotational velocity, and use any of these values in determining the vibration energy value. It is noted that a Fast Fourier Transform (FFT) could be utilized to identify vibration frequencies and amplitudes when determining each vibration energy value.

Next, in step 622, the analytics engine 122 determines whether a nwnber of determined vibration energy values is greater than a minimum integer value n. If the number of determined vibration energy values is not greater than the minimum integer value n, then the process returns to step 620 and the analytics engine determines another vibration energy value for another sample time period. If the number of determined vibration energy values is greater than the minimum integer value n, then the process proceeds to step 624.

In step 624, the analytics engine 122 determines a vibration energy integer for each sample time period based on the determined vibration energy value for each sample time period. In particular, the analytics engine 122 converts each determined vibration energy value into a vibration energy integer between 0 and n via a mapping function. An acceleration and/or displacement (directional or rotational) measurement can be used to determine each vibration energy integer. It is noted that each vibration energy integer is indicative of a level of acceleration force detected by the accelerometer 68. Then, in step 626, the inline monitoring device 50 transmits each determined vibration energy integer with the temporally corresponding pool or spa water sample telemetry data for the sample time period (e.g., ten minutes) to the server system 118, and in step 628, the server system 118 stores the stream of integers in the device data database 130.

In step 630, the analytics engine 122 identifies sample periods indicative of consistently high vibration energy based on the stored vibration energy integers, and in step 632, the analytics engine determines pool or spa pump runtime ON/OFF events based on the identified sample periods. For example, those time periods with vibration energy integers greater than a certain threshold can be determined to correspond to a pool or spa pump ON event, while those below the certain threshold can be determined to correspond to a pool or spa. pump OFF event. Next, in step 634, the analytics engine 122 detects pool or spa pump runtime events based on the determined pump ON/OFF events. That is, the pump ON/OFF events can be grouped into integer periods of time. Lastly, in step 636, the analytics engine stores the determined pool or spa pump runtime events in the device data database 130.

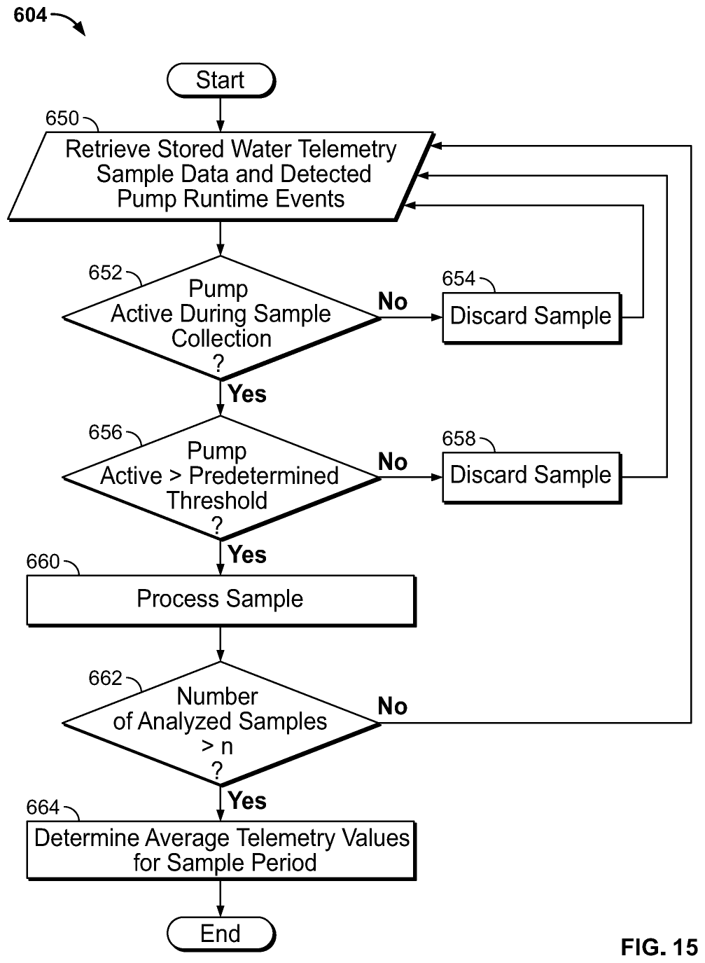

FIG. 15 is a flowchart illustrating step 604 of FIG. 13 in greater detail. As described above, the analytics engine 122 of the server system 118 can determine when the pool or spa pump is running based on the determined pool or spa pump runtime events derived from the vibration energy data detected by the accelerometer 68 of the inline monitoring device 50. These determined runtime event can then be leveraged to determine what data should be analyzed.

In step 650, the analytics engine 122 retrieves a sample of the stored streams of pool or spa water telemetry data and the detected pool or spa runtime events from the device data database 130. In step 652, the analytics engine 122 determines whether the pool or spa pump was running at the time of collection of the sample by comparing the detected pool or spa runtime events and the timestamp of when the sample was taken. If the pool or spa pump was not running when the sample was collected, then in step 654 the sample is discarded and the process returns to step 650 and the analytics engine retrieves another sample of the stored streams of pool or spa water telemetry data. If the pool or spa pump was running when the sample was collected then the process proceeds to step 656.

In step 656, the analytics engine 122 determines whether the pool or spa pump was running for a time period longer than a predetermined threshold when the sample measurement data was collected. For example, the analytics engine 122 can determine whether the pool or spa pump was running for a time period longer than 30 minutes after a pool or spa pump runtime ON event (i.e., after an initiation of the pool or spa pump), or was running for more than 30 minutes prior to collection of the data measurement. This is to ensure that the sample measurement data is representative of the whole body of pool or spa water and not just a different part of the pool or spa plumbing system. If the pool or spa pump was not running for a time period longer than the predetermined threshold when the sample measurement data was collected, then in step 658 the sample is discarded and the process returns to step 650 to retrieve another sample of the stored measurement data. If the pool or spa pump was running for a time period longer than the predetermined threshold when the sample measurement data was collected, then the process proceeds to step 660.

In step 660, the analytics engine 122 analyzes the sample measurement data to filter out nuisance values and/or noise. For example, the analytics engine 122 may leverage a data pre-processing technique, such as data binning, to filter data outliers (e.g., data spikes). Once the data sample is confirmed, the process proceeds to step 662 wherein the analytics engine 122 determines whether a number of analyzed samples of measurement data is greater than a minimum integer value n. If the number of analyzed samples of measurement data is not greater than the minimum integer value n, then the process returns to step 650 to retrieve another sample of the stored measurement data. If the number of analyzed samples of the measurement data is greater than the minimum integer value n, then the process proceeds to step 664.

In step 664, the analytics engine 122 determines average telemetry values for the analyzed samples of measurement data for a sample time period. For example, the analytics engine 122 can determine average pH, ORP, and temperature values for the analyzed samples of measurement data for a sample period including, but not limited to, a specified number of hours or a time period since the pool or spa pump runtime ON event as per the schedule. These values are utilized to generate the recommendation and water status report in step 606 of FIG. 13 that is transmitted to the remote user device 100. It is noted that the report can include, but is not limited to, a chemical level of the pool or spa water, a clarity level of the pool or spa water, and a hardness level of the pool or spa water.

Additionally, as described above, the server system 118 can transmit instructions to autonomously turn on pool/spa equipment as needed based on the calculations, recommendations, and/or report.

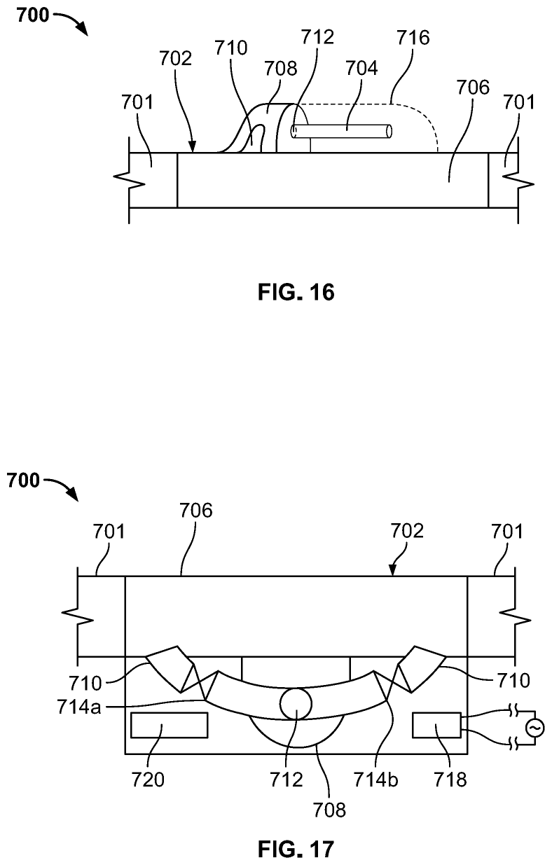

FIG. 16 is a diagram illustrating a side view of an installation of an inline monitoring system 700 installed in a pipe 701 of a pool or spa plumbing system. FIG. 17 is a partial sectional view of the inline monitoring system 700 of FIG. 16. The inline monitoring system 700 can include a junction 702 and an inline monitoring device 704 removably mounted to the junction 702. The inline monitoring device 704 can have a similar configuration to the inline monitoring device 50 described in connection with FIGS. 2-6. The junction 702 can include a body 706 and a bypass 708 extending from the body 706. The junction 702 can be installed in a pipe 701 of a pool or spa plumbing system with the pipe 701 engaged and in fluidic communication with the body 706. That is, the body 706 is installed in the pipe 701 such that water flowing through the pipe 701 will flow through the body 706. The bypass 708 extends from the body 706 and includes bypass pipes 710 and an opening 712. The bypass pipes 710 are in fluidic communication with the body 706 such that water flowing through the body 706 can flow into the bypass pipes 710 and through the bypass 708, after which the water reenters the body 706 and flows through the pipe 701. The bypass pipes 710 can be oriented parallel or perpendicular to the pipe 701.

The opening 712 in the bypass 708 can be sized and configured to receive the inline monitoring device 704, and can be in fluidic communication with the bypass pipes 710. More specifically, the inline monitoring device 704 can be inserted into the opening 712 and removably secured to the bypass 708 with a portion thereof extending into the bypass pipes 710 and exposed to the water flowing through the bypass pipes 710. Accordingly, when the inline monitoring device 704 is inserted into the opening 712 the sensors thereof are exposed to the water flowing through the bypass pipes 710 (see FIG. 17). For example, the inline monitoring device 704 can include a flow meter that is positioned within the bypass pipes 710 when the inline monitoring device 704 is inserted into the opening 712, which allows for the inline monitoring device 704 to determine if water is circulating through the pool or spa plumbing system. Thus, in this configuration, water can flow through the pipe 701, into the body 706, into a first bypass pipe 710, across the inline monitoring device 704, through the second bypass pipe 710, back into the body 706, and back into the pipe 701 where it is recirculated through the plumbing system.

The bypass pipes 710 can also include valves 714a, 714b that are positioned on opposite sides of the opening 712, as shown in FIG. 17. The valves 714a, 714b function to prevent water from exiting the opening 712 when an inline monitoring device 704 is not positioned therein.

Additionally, the bypass 708 can include a guard or cover 716 that can be positioned over the inline monitoring device 704. Specifically, the cover 716 can be rotatably connected to the body 706 or the bypass 708 so that it can be rotated between open and closed positions. When the cover 716 is in the open position, the opening 712 is exposed such that the inline monitoring device 704 can be inserted into or removed from the opening 712. When the cover 716 is in the closed position the opening 712, and the inline monitoring device 704 if inserted into the opening 712, are covered by the cover 716. In this closed position, the cover 716 protects the inline monitoring device 704 from exposure to outdoor elements including, but not limited, heat, wind, and rain.

The cover 716 can also function as a mechanical interlock mechanism with the valves 714a, 714b. In particular, the cover 716 can be connected to valves 714a, 714b such that the valves 714a, 714b are open when the cover 706 is lowered (e.g., in the closed position) and the valves 714a, 714b are closed when the cover 706 is raised (e.g., in the open position). Alternatively, the valves 714a, 714b can be configured to obstruct the cover 716 such that the cover 716 cannot be raised to remove the inline monitoring device 704 unless the valves 714a, 714b are in a closed position. The foregoing configurations ensure that water does not egress from the opening 712 during insertion or removal of the inline monitoring device 704, and prevents the inline monitoring device 704 from being removed while water is flowing through the bypass 708. For example, the valves 714a, 714b allow for the flow of water through the bypass 708 to be stopped when the inline monitoring device 704 needs to be replaced or removed, e.g., for winterization.

The junction 702 can also have a power supply 718 and electronics 720 positioned within a weatherproof compartment thereof. The power supply 718 can be, for example, a battery that can be replaced as needed. Additionally and/or alternatively, the power supply 718 can be an AC power supply such that it can plug into an AC power source to provide continuous power without the need for a battery. The electronics 720 can determine if the inline monitoring device 704 is installed in the junction 702. Additionally, in some embodiments, the electronics 720 can control the valves 714a, 714b. The junction 702 can be installed in a pipe 701 with the bypass 708 in various different configurations, e.g., on top of the body 706 (see FIG. 16) or on bottom of the body 706 (see FIG. 17), which allows for a user to ensure that the sensors of the inline monitoring device 704 are always exposed to water, even when the pump is not running.

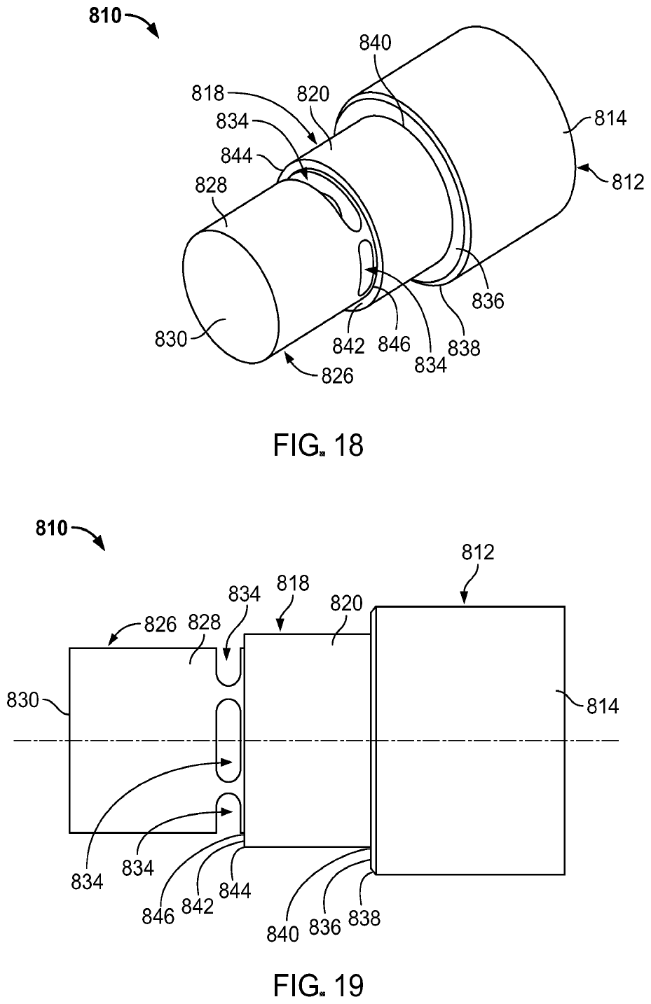

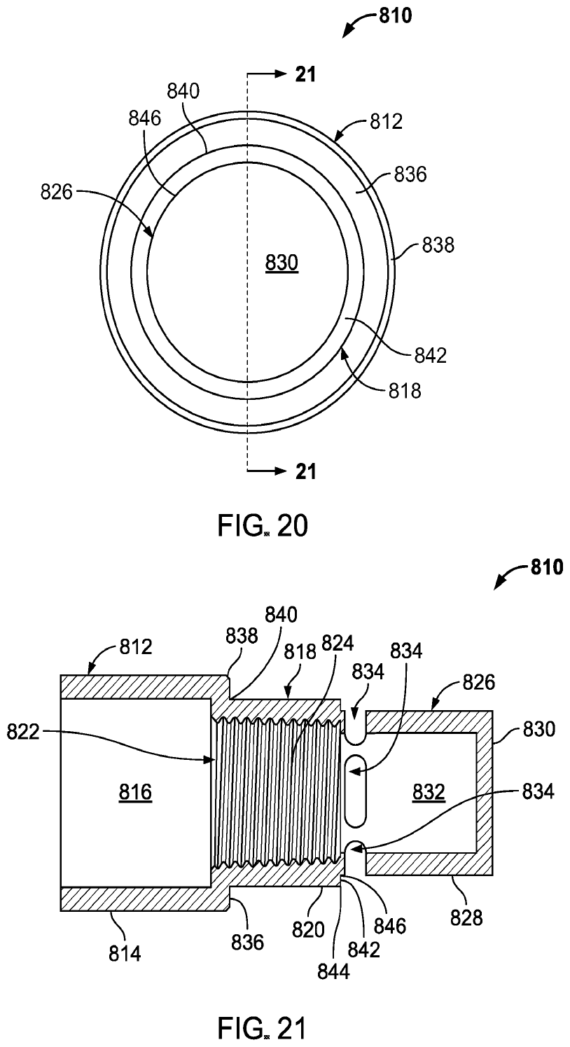

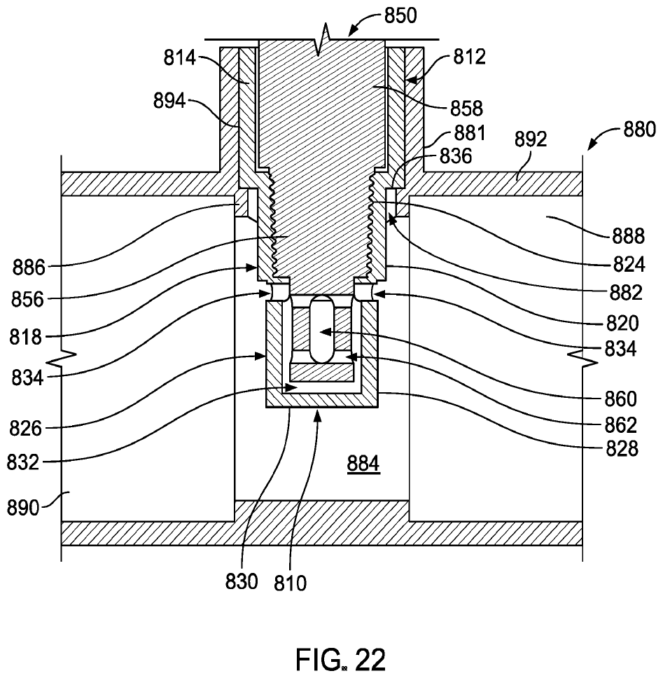

FIGS. 18-22 illustrate an adapter 810 for coupling an inline monitoring device of the present disclosure (e.g., inline monitoring device 50) with a component (e.g., a return pipe to the pool or spa or an exit pipe from the pool or spa pump) of a pool/spa plumbing system. Specifically, FIG. 18 is a perspective view of the adapter 810, FIG. 19 is a side elevation view of the adapter 810, FIG. 20 is a bottom view of the adapter 810, FIG. 21 is a cross-sectional view of the adapter 810 taken along line A-A of FIG. 20, and FIG. 22 is a partial sectional view illustrating an exemplary configuration of the adapter 810 installed in a pool/spa component, e.g., a tee union 880 of a pool or spa plumbing system, and having an inline monitoring device 850 engaged therewith. It is noted that the adapter 810 can similarly couple an inline monitoring device of the present disclosure to a pump (e.g., the pressure side of the pump through a pressure side drain hole (pressure sump) or the vacuum side of the pump through a vacuum side drain hole (vacuum sump)), a filter (e.g., through a drain hole of the filter), a heater (e.g., a heater water manifold), or any other component or water reservoir within the plumbing system of the pool or spa that pool/spa water is circulated through. Accordingly, reference to the pipe 880 in connection with FIGS. 18-22 should be understood to be one example of a component that the adapter 880 can be used in connection with, and any description associated therewith should be understood to be equally applicable to any other component of the pool or spa plumbing system through which pool/spa water is circulated.

As shown in FIGS. 18-21, the adapter 810 can include a cylindrical collar 812, a threaded collar 818 (see, e.g., FIG. 21), and reservoir portion 826. The cylindrical collar 812 can include an annular wall 814 defining an interior cavity 816, and the threaded collar 818 can include an annular wall 820 defining an interior cavity 822. The threaded collar 818 also includes threading 824 disposed on an interior surface of the annular wall 820 thereof. The reservoir portion 826 can include an annular wall 828 and a circular bottom wall 830 that, together, define an interior chamber 832 and can also include one or more elongate slots 838 disposed through the annular wall 828 and arranged radially thereabout that provide a flow path from the exterior of the reservoir potion 826 to the interior chamber 832. Additionally, the interior cavity 816 of the cylindrical collar 812, the interior cavity 816 of the threaded collar 818, and the interior chamber 832 of the reservoir portion 826 can be in fluidic communication.

The cylindrical collar 812, the threaded collar 818, and the reservoir portion 826 can be integrally formed from a single piece of material (e.g., by way of injection molding, or the like) and the cylindrical collar 812, the threaded collar 818. and the reservoir portion 826 can have outer diameters of varying dimensions. For example, the cylindrical collar 812 can have an outer diameter that is greater than the outer diameter of the threaded collar 818. As such, the adapter 810 can include an annular shoulder 836 extending from a lower edge 838 of the cylindrical collar 812 to an upper edge 840 of the threaded collar 818 and being disposed generally perpendicular to the annular walls 814, 820 of the cylindrical collar 812 and the threaded collar 818, respectively. Similarly, the threaded collar 818 can have an outer diameter that is greater than the outer diameter of the reservoir portion 826. As such, the adapter 810 can include an annular shoulder 842 extending from a lower edge 844 of the threaded collar 818 to an upper edge 846 of the reservoir portion 826 and being disposed generally perpendicular to the annular walls 820 and 828 of the threaded collar 818 and reservoir portion 826, respectively.

According to some embodiments of the present disclosure, the lower edge 838 of the cylindrical collar 812 can be chamfered, or otherwise adapted, to facilitate insertion into a fitting or component of the pool or spa plumbing system (e.g., the boss 881 shown in FIG. 22) through which pool/spa water is circulated. The adapter 810 can be formed of a plastic material that is resilient to deformation and damage from impact, chemicals, heat, or other conditions that may be present in a pool or spa plumbing system. For example, the adapter 810 can be formed of a plastic material such as acrylonitrile butadiene styrene (ABS).

FIG. 22 is a partial cross-sectional diagram illustrating an exemplary configuration of the adapter 810 inserted into the tee union 880 and having the inline monitoring device 850 threadingly engaged therewith, thereby coupling the inline monitoring device 850 to the tee union 880 through which pool/spa water flows. The inline monitoring device 850 and the tee union 880 can be substantially similar to the inline monitoring device 50 and tee union 80, described in connection with e.g., FIGS. 2-5, except for distinctions noted herein.

The inline monitoring device 850 comprises a housing (not shown) coupled to a mounting rod 858. As described in connection with FIGS. 2-6, the housing can enclose electronic components that wirelessly transmit the monitored and measured characteristics of the pool or spa. water flowing through the pipe, in addition to other related data, to at least one of a client application being executed on a remote device 100 of a user (e.g., an application operating on a smart telephone) and/or a hosted service (e.g., a server system) for analysis

The mounting rod 858 includes a cavity 860 at an end thereof opposite the housing, which encases at least one sensor for monitoring and measuring characteristics of the water flowing through the pipe of the pool or spa plumbing system. The mounting rod 858 also includes a threaded portion 856 adjacent to the cavity 860, which is configured to couple the inline monitoring device 850 to the adapter 810 or a pipe of a pool or spa plumping system, such that the inline monitoring device 850 is inline with the pipe when coupled thereto, with the sensor extending into the pipe. As such, the sensor is exposed to water within the pipe. The sensor can include any one, or combination, of sensors described in connection with sensor 57 of inline monitoring device 50. Additionally, as described in connection with sensor 57, an optional flowmeter can be integrated into the sensor or be integrated with the inline monitoring device 850 independent of the sensor. As shown, the submerged portion of the mounting rod 858 may include one or more defined openings 862 in communication with the cavity 860 to permit water flowing through the pipe and tee union 880 to contact the sensor and/or and the flowmeter in order to monitor and measure the characteristics of the water flowing through the pipe.

The tee union 880 can include a first flange 888 configured to receive an end of a first pipe (not shown) a second flange 890 configured to receive an end of a second pipe (not shown), and a boss 881 configured to receive a pool or spa component, such as the adapter 810 and/or the inline monitoring device 850. The boss 881 includes an aperture 882 that is positioned concentrically therein and extends through an exterior wall 892 of the tee union 880 and into an interior 884 of the tee union 880.

Those of ordinary skill in the art will understand that the tee union 880 can be a standard and/or preexisting pool or spa component connection and as such, the boss 881 may not be correctly sized and configured to receive the threaded portion 856 of the inline monitoring device 850 without modification or replacement. For example, the boss 881 may have an inner diameter that is too wide (e.g., allows the mounting rod 858 to pass therethrough), may not have threading that is compatible with the threaded portion 856 of the mounting rod 858, or may not have any threading at all, as shown in FIG. 22.

Accordingly, the adapter 810 can be sized and configured to couple the inline monitoring device 850 to the tee union 880, e.g., where the tee union 880 has a boss 881 without threading for engaging the threaded portion 856 of the mounting rod 858. For example, as shown in FIG. 22, the annular wall 814 of the cylindrical collar 812 can have an inner diameter sized to receive the mounting rod 858 of the inline monitoring device 850 and an outer diameter sized to engage an interior wall 894 of the boss 881. The shoulder 836 of the adapter 810 can rest on a flange 886 positioned about the aperture 882 of the boss 881, thereby limiting the distance the adapter 810 and inline monitoring device 850 can extend into the interior 884 of the tee union 880. Similarly, the outer diameter of the annular wall 820 of the threaded collar 818 of the adapter 810 can be sized to pass through the aperture 882 of the tee union 880. while the inner diameter and threading 824 of the annular wall 820 can be sized and configured to threadedly engage the threaded portion 856 of the inline monitoring device 850. According to some aspects of the present disclosure, the adapter 810 can be secured to the tee union 810 by way of a friction fit between the cylindrical collar 812 and the interior surface 894 of the boss 881, or by way of an adhesive, cement, sealant, or the like disposed therebetween. According to still further aspects, where the boss of the tee union is threaded (see, e.g., boss 81 of FIG. 5), the annular wall 814 of the cylindrical collar 812 can be provided with exterior threading (not shown) configured to engage and be received by the threaded boss of the tee union, thereby securing the adapter to the tee union.

The adapter enhances operation and longevity of the inline monitoring device 850. As discussed above, the reservoir portion 826 of the adapter 810 includes the interior chamber 832 and one or more slots 838 disposed through the annular wall 828 and arranged radially thereabout. As shown in FIG. 22, the chamber 832 can be sized to receive and surround the end of the mounting rod 858 having the cavity 860 which houses the sensor. That is, the chamber 832 can be larger than the end of the mounting rod 858, e.g., it can have a greater diameter and/or height. As such, when the mounting rod 858 is engaged with the adapter 810, the mounting rod cavity 860 is positioned within the adapter chamber 832, and the one or more openings 862 of the mounting rod 858 place the mounting rod cavity 860, and thus the sensor(s) positioned therein, in fluidic communication with the chamber 832. Accordingly, in operation, water flowing through the interior 884 of the tee union 880 can pass through the one or more slots 834 in the reservoir portion 826 of the adapter 810, enter and fill the chamber 832, travel through the openings 862 in the mounting rod 858, and enter the cavity 860 where the water contacts the sensor and/or the flowmeter so that the characteristics of the water flowing through the pipe can be measured and monitored.

The foregoing configuration allows continuously circulating water to enter the reservoir portion 826 and contact the sensor of the inline monitoring device 850 while also surrounding and protecting the sensor from the full force of the water as it flows through the pipes and tee union 880. Furthennore, the chamber 832 acts as a reservoir for water when water is not actively flowing through the tee union 880, e.g., when the pump is off, a blockage occurs, etc., or when the level (e.g., the vertical depth or height) of the water flowing through the tee union 880 drops below a level sufficient to make contact with the sensor (e.g., below the one or more slots 834). In such situations, the sensor of the inline monitoring device 850 is kept wet by the water stored in the chamber 832 of the reservoir portion 826 of the adapter 810, thereby extending the life of the sensor and/or inline monitoring device 850.

As noted above, while FIG. 22 illustrates the adapter 810 and inline monitoring device 850 engaged with a tee union 880, it should be understood that the adapter 810 and/or inline monitoring device 850 can be engaged with other components of the pool or spa plumbing system, such as, but not limited to, a pump, a filter, a heater, etc., depending on a user's needs and desires. This installation flexibility allows the adapter 810 and/or inline monitoring device 850 to be installed in different locations depending on ease of installation and desired exposure to pool/spa water circulating through the pool or spa plumbing system. Additionally, it should be understood that the adapter 810 and tee union 880 could be formed as a single unit that is connectible to pool/spa piping.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

What is claimed is:

1. A system for monitoring pool or spa water, comprising:
a server including an analytics engine;
a monitoring device configured to be engaged with a component of a pool or spa plumbing system, the monitoring device comprising:
at least one sensor configured to measure a characteristic of water within the component, the at least one sensor being exposed to water within the component when the monitoring device is engaged with the component;
a memory;
a communication module; and
a processor in communication with the at least one sensor, the memory, and the communication module, the processor configured to establish communication between the inline monitoring device and the server and communicate data related to the characteristic measured by the at least one sensor,
wherein the monitoring device communicates the data to the server,
wherein the server receives the data and the analytics engine (a) processes the data in connection with a runtime schedule of the pool or spa pump, (b) determines if the data was measured at a time when the pool or spa pump was operational, and (c) discards the data if it is determined that the data was not measured at a time when the pool or spa pump was operational.

2. The system of claim 1, wherein the server includes a calculation engine, the calculation engine generating a pool or spa water status report based on the data.

3. The system of claim 2, wherein the pool or spa water status report includes instructions to initiate one or more actions in connection with the pool or spa water.

4. The system of claim 1, wherein the analytics engine determines if the pool or spa pump was operational for more than a predetermined threshold prior to the time when the data was measured, and discards the data if it is determined that the pump was not operational for more than the predetermined threshold prior to the time when the data was measured.

5. The system of claim 1, wherein the analytics engine processes the data to filter out data outliers.

6. The system of claim 1, wherein the analytics engine determines an average value for the data over a time period.

7. The system of claim 6, wherein the server generates a pool or spa water status report based on the average value for the data over the time period.

8. The system of claim 7, wherein the pool or spa water status report includes instructions to initiate one or more actions in connection with the pool or spa water.

9. The system of claim 1, wherein the communication module is one of a wireless communication module and a wired communication module.

10. The system of claim 1, wherein the component is a pipe, a pump, a filter, or a heater.

11-19. (canceled)

20. A system for monitoring pool or spa water and determining an operational status of a pool or spa pump, comprising:
a server including an analytics engine;
a monitoring device configured to be engaged with a component of a pool or spa plumbing system, the monitoring device comprising:
at least one sensor configured to measure a characteristic of water within the component, the at least one sensor being exposed to water within the component when the monitoring device is engaged with the component;
an accelerometer;
a memory;
a communication module; and
a processor in communication with the at least one sensor, the accelerometer, the memory, and the communication module, the processor configured to establish communication between the inline monitoring device and the server, and determine vibration energy integers for a plurality of sample time periods based on measurements from the accelerometer,
wherein the monitoring device communicates the vibration energy integers and the data to the server,
wherein the server receives the vibration energy integers and the data, and the analytics engine (a) determines runtime events of the pool or spa pump including operational periods based on the vibration energy integers, (b) processes the data in connection with the runtime events of the pool or spa pump, (c) determines if the data was measured during an operational period of the pool or spa pump, and (d) discards the data if it is determined that the data was not measured during an operational period of the pool or spa pump.

21. The system of claim 20, wherein the server includes a calculation engine, the calculation engine generating a pool or spa water status report based on the data.

22. The system of claim 21, wherein the pool or spa water status report includes instructions to initiate one or more actions in connection with the pool or spa water.

23. The system of claim 20, wherein the analytics engine determines if the pool or spa pump was operational for more than a predetermined threshold prior to the time when the data was measured, and discards the data if it is determined that the pump was not operational for more than the predetermined threshold prior to the time when the data was measured.

24. The system of claim 23, wherein the analytics engine processes the data to filter out data outliers.

25. The system of claim 24, wherein the analytics engine determines an average value for the data over a time period.

26. The system of claim 25, wherein the server generates a pool or spa water status report based on the average value for the data over the time period.

27. The system of claim 26, wherein the pool or spa water status report includes instructions to initiate one or more actions in connection with the pool or spa water.

28. The system of claim 20, wherein the processor determines a vibration energy value for the plurality of sample time periods based on measurements from the accelerometer and determines the vibration energy integer for each sample time period based on the vibration energy value for that sample time period.

29. The system of claim 28, wherein the analytics engine identifies sample time periods of consistent high vibration energy based on the vibration energy integers, and determines runtime events of the pool or spa pump based on the sample time periods of consistent high vibration energy.

30. The system of claim 20, wherein the communication module is one of a wireless communication module and a wired communication module.

31. The system of claim 20, wherein the component is a pipe, a pump, a filter, or a heater.

32. A method of monitoring pool or spa water, comprising:
measuring a characteristic of pool or spa water within a component of a pool or spa plumbing system using at least one sensor;
transmitting data related to the characteristic of the pool or spa water measured by the at least one sensor to a server, the data including a series of data points each having a timestamp;
processing the data in connection with a runtime schedule of the pool or spa pump including operational periods of the pool or spa pump;
determining if the data was measured during an operational period of the pool or spa pump; and
discarding the data if it is determined that the data was not measured during an operational period of the pool or spa pump.

33. The method of claim 32, comprising:
generating a pool or spa water status report based on the data.

34. The method of claim 32, comprising:
transmitting instructions to initiate one or more actions in connection with the pool or spa water.

35. The method of claim 32, comprising:
determining if the pool or spa pump was operational for more than a predetermined threshold prior to the time when the data was measured; and
discarding the data if it is determined that the pump was not operational for more than the predetermined threshold prior to the time when the data was measured.

36. The method of claim 32, comprising:
processing the data to filter out data outliers.

37. The method of claim 32, comprising:
determining an average value for the data over a time period.

38. The method of claim 37, comprising:
generating a pool or spa water status report based on the data.

39. The method of claim 37, comprising:
transmitting instructions to initiate one or more actions in connection with the pool or spa water.

40. The method of claim 32, wherein the data is transmitted wirelessly.

41. The method of claim 32, wherein the component is a pipe, a pump, a filter, or a heater.

42-52. (canceled)

53. A method of monitoring pool or spa water and determining an operational status of a pool or spa pump, comprising:
measuring a characteristic of pool or spa water within a component of a pool or spa plumbing system using at least one sensor;
measuring an acceleration or displacement associated with the component using an accelerometer;
determining vibration energy integers for a plurality of sample time periods based on the acceleration or displacement measured by the accelerometer;
transmitting the vibration energy integers and the data related to the characteristic of the pool or spa water measured by the at least one sensor to a server;
determining runtime events of the pool or spa pump including operational periods based on the vibration energy integers;
processing the data in connection with the runtime events of the pool or spa pump;
determining if the data was measured during an operational period of the pool or spa pump; and
discarding the data if it is determined that the data was not measured during an operational period of the pool or spa pump.

54. The method of claim 53, comprising:
generating a pool or spa water status report based on the data.

55. The method of claim 53, comprising:
transmitting instructions to initiate one or more actions in connection with the pool or spa water.

56. The method of claim 53, comprising:
determining if the pool or spa pump was operational for more than a predetermined threshold prior to the time when the data was measured; and
discarding the data if it is determined that the pump was not operational for more than the predetermined threshold prior to the time when the data was measured.

57. The method of claim 56, comprising:
processing the data to filter out data outliers.

58. The method of claim 57, comprising:
determining an average value for the data over a time period.

59. The method of claim 58, comprising:
generating a pool or spa water status report based on the data.

60. The method of claim 58, comprising:
transmitting instructions to initiate one or more actions in connection with the pool or spa water.

61. The method of claim 53, comprising:
determining a vibration energy value for the plurality of sample time periods based on the acceleration or displacement measurements of the accelerometer; and
determining the vibration energy integer for each sample time period based on the vibration energy value for that sample time period.

62. The method of claim 61, comprising:
identifying sample time periods of consistent high vibration energy based on the vibration energy integers; and
determining runtime events of the pool or spa pump based on the sample time periods of consistent high vibration energy.

63. The method of claim 53, wherein the vibration energy integers and the data are transmitted wirelessly.

64. The method of claim 53, wherein the component is a pipe, a pump, a filter, or a heater.

65-70. (canceled)
